(19) United States
(12) Patent Application Publication
(10) Pub. No.: US 2023/0125073 A1
(43) Pub. Date: Apr. 27, 2023

(54) System and method for improving efficacy of supervised learning

(71) Applicant: nference, inc., Cambridge, MA (US)

(72) Inventors: Bharathwaj RAGHUNATHAN, Toronto (CA); Rakesh BARVE, Bangalore (IN); Sairam BADE, Ameenabad Anathagiri Suryape (IN); Vishal JAIN, Toronto (CA); Akash ANAND, Bhagalpur (IN); Ajit RAJASEKHARAN, West Windsor, NJ (US)

(21) Appl. No.: 18/048,197

(22) Filed: Oct. 20, 2022

Related U.S. Application Data
(60) Provisional application No. 63/270,243, filed on Oct. 21, 2021.

(51) Int. Cl. G06N 3/09

(52) U.S. Cl. CPC G06N 3/09

(57) ABSTRACT

In one aspect, a method is disclosed that includes selecting a first plurality of input candidates from a corpus of data; mapping the first plurality of input candidates onto a pretrained vector space of a pretrained model; clustering the first plurality of input candidates in the pretrained vector space; adding the first plurality of input candidates to a plurality of queues for labelling; and labelling the first plurality of input candidates.

### RELATED APPLICATIONS

This application claims priority to U.S. Provisional Application No. 63/270,243, filed Oct. 21, 2021, which is incorporated by reference herein in its entirety.

### FIELD OF INVENTION

Embodiments of the present disclosure relate to systems, methods, and computer readable media for analyzing underlying relationships in data for efficiently training a machine learning model

### BACKGROUND

Despite the surge in self-supervised methods for representation learning that is then used to solve traditionally supervised tasks (e.g. classifying a picture as a cat or dog, segmenting objects in an image) without the need for labeled data, there still remains a large number of tasks where supervised learning is essential. This is for those cases when the task involves labels that cannot be inferred from available input data, notwithstanding the fact that in some cases, joint learning across media types (image and text) if such data is available, can be used to avoid explicitly labeling data. A task where supervised learning cannot be avoided is detecting the relation between two phrases in a sentence. This can be done in a self-supervised manner for a large number of cases, but requires a supervised model to learn complex relationships between the phrases.

### BRIEF SUMMARY OF THE EMBODIMENTS

In one aspect, a method includes selecting a first plurality of input candidates from a corpus of data; mapping the first plurality of input candidates onto a pretrained vector space of a pretrained model; clustering the first plurality of input candidates in the pretrained vector space; adding the first plurality of input candidates to a plurality of queues for labelling; and labelling the first plurality of input candidates.

In some embodiments, labelling the first plurality of input candidates is performed by humans.

In some embodiments, labelling the first plurality of input candidates is performed algorithmically.

In some embodiments, labelling includes identifying cluster centroids in the pretrained vector space.

In some embodiments, the pretrained vector space is created by mapping input to sparse/dense distributed representations.

In some embodiments, the pretrained vector space includes learned parameters of a probability distribution.

In some embodiments, the pretrained vector space is learned by performing density estimation.

In some embodiments, the pretrained model is selected from a group consisting of transformers, convolutional neural networks, recurrent neural networks, graph neural networks, and combinations thereof.

In some embodiments, the method further includes partitioning the labeled first plurality of input candidates into a train set, a development set, a test set, and an out-of-distribution set, wherein partitioning includes: adding labeled cluster centroids in the pretrained vector space from the first plurality of input candidates to the train set; adding labeled cluster children in the pretrained vector space from the first plurality of input candidates to one of the development set and the test set; and adding labeled singletons in the pretrained vector space from the first plurality of input candidates to one of the train set and the out-of-distribution set.

In some embodiments, the method further includes creating a fine tuned model.

In some embodiments, wherein creating the fine tuned model includes using the pretrained model to create the fine tuned model.

In some embodiments, the method further includes assigning a first plurality of outputs using the fine tuned model.

In some embodiments, the fine tuned model is selected from a group consisting of transformers, convolutional neural networks, recurrent neural networks, graph neural networks, and combinations thereof.

In some embodiments, the method further includes evaluating performance of the fine tuned model on the test set, wherein evaluating the performance of the fine tuned model includes: mapping the test set onto a fine tuned vector space; clustering the test set in the fine tuned vector space; quantifying heterogeneity of test set clusters in the fine tuned vector space; and providing a confidence score for the fine tuned model.

In some embodiments, the method further includes labelling a second plurality of input candidates from the corpus of data, wherein labelling the second plurality of input candidates includes: mapping the train set and development set onto the pretrained vector space and the fine tuned vector space; clustering the train set and development set in the pretrained vector space and the fine tuned vector space; identifying heterogeneous clusters and singletons in the fine tuned vector space; selecting the second plurality of input candidates such that the second plurality of input candidates are near to at least one of the heterogeneous clusters and singletons in the fine tuned vector space; and labelling the second plurality of input candidates.

In some embodiments, the method further includes partitioning the labeled second plurality of input candidates into the train set, the development set, the test set, and the out-of-distribution set, wherein partitioning includes: adding labeled cluster centroids from the second plurality of input candidates to the train set; adding labeled cluster children from the second plurality of input candidates to one of the development set and the test set; and adding labeled singletons from the second plurality of input candidates to the one of the train set and the out-of-distribution set.

In some embodiments, labelling of the second plurality of input candidates includes algorithmically labelling the second plurality of input candidates.

In some embodiments, the method further includes assigning the confidence score for the labelling of the second plurality of input candidates using a bipartite graph of the pretrained vector space and the fine tuned vector space.

In some embodiments, the method further includes evaluating performance of an ensemble of two or more fine tuned models on the test set, wherein evaluating the performance of the ensemble of two or more fine tuned models includes determining whether the ensemble of two or more fine tuned models concur on an output; mapping the train, development, and test sets onto one or more pairs of pretrained vector spaces and fine tuned vector spaces; and assigning a confidence score for each of the two or more fine tuned models using a bipartite graph for each of the one or more pairs of pretrained vector spaces and fine tuned vector spaces.

In some embodiments, the method further includes selecting a third plurality of input candidates from the corpus of data; labeling the third plurality of input candidates using the fine tuned model; mapping the third plurality of input candidates onto the pretrained vector space and a fine tuned vector space; clustering the third plurality of input candidates in the pretrained vector space and the fine tuned vector space; identifying heterogeneous clusters and singletons in the fine tuned vector space; and assigning a confidence score for the labelling of the third plurality of input candidates using a bipartite graph of the pretrained vector space and the fine tuned vector space.

In some embodiments, the method further includes labeling a third plurality of input candidates using an ensemble of two or more fine tuned models on the third plurality of input candidates; determining whether the ensemble of two or more fine tuned models concur on labeling of the third plurality of input candidates; mapping the third plurality of input candidates onto one or more pairs of pretrained vector spaces and fine tuned vector spaces; and assigning a confidence score for each of the two or more fine tuned models using a bipartite graph for each of the one or more pairs of pretrained vector spaces and fine tuned vector spaces.

In some embodiments, the method further includes selecting a plurality of failed inputs for examination, wherein the plurality of failed inputs are inputs of the third plurality of inputs that have a low confidence score; selecting a plurality of neighbors of each of the plurality of failed inputs; labelling the plurality of neighbors; and partitioning the plurality of neighbors onto the train set, the development set, the test set, and the out-of-distribution set.

In some embodiments, partitioning the plurality of neighbors includes adding labeled cluster centroids from the plurality of neighbors to the train set; adding labeled cluster children from the plurality of neighbors to one of the development set and the test set; and adding labeled singletons from the plurality of neighbors to one of the train set and the out-of-distribution set.

In one aspect, a non-transitory memory; and one or more hardware processors configured to read instructions from the non-transitory memory that, when executed cause the one or more hardware processors to perform operations including: selecting a first plurality of input candidates from a corpus of data; mapping the first plurality of input candidates onto a pretrained vector space of a pretrained model; clustering the first plurality of input candidates in the pretrained vector space; adding the first plurality of input candidates to a plurality of queues for labelling; and labelling the first plurality of input candidates.

In some embodiments, labelling the first plurality of input candidates is performed by humans.

In some embodiments, labelling the first plurality of input candidates is performed algorithmically.

In some embodiments, labelling includes identifying cluster centroids in the pretrained vector space.

In some embodiments, the pretrained vector space is created by mapping input to sparse/dense distributed representations.

In some embodiments, the pretrained vector space includes learned parameters of a probability distribution.

In some embodiments, the pretrained vector space is learned by performing density estimation.

In some embodiments, the pretrained model is selected from a group consisting of transformers, convolutional neural networks, recurrent neural networks, graph neural networks, and combinations thereof.

In some embodiments, the operations further include partitioning the labeled first plurality of input candidates into a train set, a development set, a test set, and an out-of-distribution set, wherein partitioning includes: adding labeled cluster centroids in the pretrained vector space from the first plurality of input candidates to the train set; adding labeled cluster children in the pretrained vector space from the first plurality of input candidates to one of the development set and the test set; and adding labeled singletons in the pretrained vector space from the first plurality of input candidates to one of the train set and the out-of-distribution set.

In some embodiments, the operations further include creating a fine tuned model.

In some embodiments, creating the fine tuned model includes using the pretrained model to create the fine tuned model.

In some embodiments, the operations further include assigning a first plurality of outputs using the fine tuned model.

In some embodiments, the fine tuned model is selected from a group consisting of transformers, convolutional neural networks, recurrent neural networks, graph neural networks, and combinations thereof.

In some embodiments, the operations further include evaluating performance of the fine tuned model on the test set, wherein evaluating the performance of the fine tuned model includes: mapping the test set onto a fine tuned vector space; clustering the test set in the fine tuned vector space; quantifying heterogeneity of test set clusters in the fine tuned vector space; and providing a confidence score for the fine tuned model.

In some embodiments, the operations further include labelling a second plurality of input candidates from the corpus of data, wherein labelling the second plurality of input candidates includes: mapping the train set and development set onto the pretrained vector space and the fine tuned vector space; clustering the train set and development set in the pretrained vector space and the fine tuned vector space; identifying heterogeneous clusters and singletons in the fine tuned vector space; selecting the second plurality of input candidates such that the second plurality of input candidates are near to at least one of the heterogeneous clusters and singletons in the fine tuned vector space; and labelling the second plurality of input candidates.

In some embodiments, the operations further include partitioning the labeled second plurality of input candidates into the train set, the development set, the test set, and the out-of-distribution set, wherein partitioning includes: adding labeled cluster centroids from the second plurality of input candidates to the train set; adding labeled cluster children from the second plurality of input candidates to one of the development set and the test set; and adding labeled singletons from the second plurality of input candidates to the one of the train set and the out-of-distribution set.

In some embodiments, labelling of the second plurality of input candidates includes algorithmically labelling the second plurality of input candidates.

In some embodiments, the operations further include assigning the confidence score for the labelling of the second plurality of input candidates using a bipartite graph of the pretrained vector space and the fine tuned vector space.

In some embodiments, the operations further include evaluating performance of an ensemble of two or more fine tuned models on the test set, wherein evaluating the performance of the ensemble of two or more fine tuned models includes determining whether the ensemble of two or more fine tuned models concur on an output; mapping the train, development, and test sets onto one or more pairs of pretrained vector spaces and fine tuned vector spaces; and assigning a confidence score for each of the two or more fine tuned models using a bipartite graph for each of the one or more pairs of pretrained vector spaces and fine tuned vector spaces.

In some embodiments, the operations further include selecting a third plurality of input candidates from the corpus of data; labeling the third plurality of input candidates using the fine tuned model; mapping the third plurality of input candidates onto the pretrained vector space and a fine tuned vector space; clustering the third plurality of input candidates in the pretrained vector space and the fine tuned vector space; identifying heterogeneous clusters and singletons in the fine tuned vector space; and assigning a confidence score for the labelling of the third plurality of input candidates using a bipartite graph of the pretrained vector space and the fine tuned vector space.

In some embodiments, the operations further include labeling a third plurality of input candidates using an ensemble of two or more fine tuned models on the third plurality of input candidates; determining whether the ensemble of two or more fine tuned models concur on labeling of the third plurality of input candidates; mapping the third plurality of input candidates onto one or more pairs of pretrained vector spaces and fine tuned vector spaces; and assigning a confidence score for each of the two or more fine tuned models using a bipartite graph for each of the one or more pairs of pretrained vector spaces and fine tuned vector spaces.

In some embodiments, the operations further include selecting a plurality of failed inputs for examination, wherein the plurality of failed inputs are inputs of the third plurality of inputs that have a low confidence score; selecting a plurality of neighbors of each of the plurality of failed inputs; labelling the plurality of neighbors; and partitioning the plurality of neighbors onto the train set, the development set, the test set, and the out-of-distribution set.

In some embodiments, partitioning the plurality of neighbors includes: adding labeled cluster centroids from the plurality of neighbors to the train set; adding labeled cluster children from the plurality of neighbors to one of the development set and the test set; and adding labeled singletons from the plurality of neighbors to one of the train set and the out-of-distribution set.

In one aspect non-transitory computer-readable medium storing instructions that, when executed by one or more hardware processors, cause the one or more hardware processors to perform operations including: selecting a first plurality of input candidates from a corpus of data; mapping the first plurality of input candidates onto a pretrained vector space of a pretrained model; clustering the first plurality of input candidates in the pretrained vector space; adding the first plurality of input candidates to a plurality of queues for labelling; and labelling the first plurality of input candidates.

In some embodiments, labelling the first plurality of input candidates is performed by humans.

In some embodiments, labelling the first plurality of input candidates is performed algorithmically.

In some embodiments, labelling includes identifying cluster centroids in the pretrained vector space.

In some embodiments, the pretrained vector space is created by mapping input to sparse/dense distributed representations.

In some embodiments, the pretrained vector space includes learned parameters of a probability distribution.

In some embodiments, the pretrained vector space is learned by performing density estimation.

In some embodiments, the pretrained model is selected from a group consisting of transformers, convolutional neural networks, recurrent neural networks, graph neural networks, and combinations thereof.

In some embodiments, the operations further include partitioning the labeled first plurality of input candidates into a train set, a development set, a test set, and an out-of-distribution set, wherein partitioning includes: adding labeled cluster centroids in the pretrained vector space from the first plurality of input candidates to the train set; adding labeled cluster children in the pretrained vector space from the first plurality of input candidates to one of the development set and the test set; and adding labeled singletons in the pretrained vector space from the first plurality of input candidates to one of the train set and the out-of-distribution set.

In some embodiments, the operations further include creating a fine tuned model.

In some embodiments, creating the fine tuned model includes using the pretrained model to create the fine tuned model.

In some embodiments, the operations further include assigning a first plurality of outputs using the fine tuned model.

In some embodiments, the fine tuned model is selected from a group consisting of transformers, convolutional neural networks, recurrent neural networks, graph neural networks, and combinations thereof.

In some embodiments, the operations further include evaluating performance of the fine tuned model on the test set, wherein evaluating the performance of the fine tuned model includes: mapping the test set onto a fine tuned vector space; clustering the test set in the fine tuned vector space; quantifying heterogeneity of test set clusters in the fine tuned vector space; and providing a confidence score for the fine tuned model.

In some embodiments, the operations further include labelling a second plurality of input candidates from the corpus of data, wherein labelling the second plurality of input candidates includes: mapping the train set and development set onto the pretrained vector space and the fine tuned vector space; clustering the train set and development set in the pretrained vector space and the fine tuned vector space; identifying heterogeneous clusters and singletons in the fine tuned vector space; selecting the second plurality of input candidates such that the second plurality of input candidates are near to at least one of the heterogeneous clusters and singletons in the fine tuned vector space; and labelling the second plurality of input candidates.

In some embodiments, the operations further include partitioning the labeled second plurality of input candidates into the train set, the development set, the test set, and the out-of-distribution set, wherein partitioning includes: adding labeled cluster centroids from the second plurality of input candidates to the train set; adding labeled cluster children from the second plurality of input candidates to one of the development set and the test set; and adding labeled singletons from the second plurality of input candidates to the one of the train set and the out-of-distribution set.

In some embodiments, labelling of the second plurality of input candidates includes algorithmically labelling the second plurality of input candidates.

In some embodiments, the operations further include assigning the confidence score for the labelling of the second plurality of input candidates using a bipartite graph of the pretrained vector space and the fine tuned vector space.

In some embodiments, the operations further include evaluating performance of an ensemble of two or more fine tuned models on the test set, wherein evaluating the performance of the ensemble of two or more fine tuned models includes determining whether the ensemble of two or more fine tuned models concur on an output; mapping the train, development, and test sets onto one or more pairs of pretrained vector spaces and fine tuned vector spaces; and assigning a confidence score for each of the two or more fine tuned models using a bipartite graph for each of the one or more pairs of pretrained vector spaces and fine tuned vector spaces.

In some embodiments, the operations further include selecting a third plurality of input candidates from the corpus of data; labeling the third plurality of input candidates using the fine tuned model; mapping the third plurality of input candidates onto the pretrained vector space and a fine tuned vector space; clustering the third plurality of input candidates in the pretrained vector space and the fine tuned vector space; identifying heterogeneous clusters and singletons in the fine tuned vector space; and assigning a confidence score for the labelling of the third plurality of input candidates using the bipartite graph of the pretrained vector space and the fine tuned vector space.

In some embodiments, the operations further include labeling a third plurality of input candidates using an ensemble of two or more fine tuned models on the third plurality of input candidates; determining whether the ensemble of two or more fine tuned models concur on labeling of the third plurality of input candidates; mapping the third plurality of input candidates onto one or more pairs of pretrained vector spaces and fine tuned vector spaces; and assigning a confidence score for each of the two or more fine tuned models using the bipartite graph for each of the one or more pairs of pretrained vector spaces and fine tuned vector spaces.

In some embodiments, the operations further include selecting a plurality of failed inputs for examination, wherein the plurality of failed inputs are inputs of the third plurality of inputs that have a low confidence score; selecting a plurality of neighbors of each of the plurality of failed inputs; labelling the plurality of neighbors; and partitioning the plurality of neighbors onto the train set, the development set, the test set, and the out-of-distribution set.

In some embodiments, the operations further include adding labeled cluster centroids from the plurality of neighbors to the train set; adding labeled cluster children from the plurality of neighbors to one of the development set and the test set; and adding labeled singletons from the plurality of neighbors to one of the train set and the out-of-distribution set.

Any one of the embodiments disclosed herein may be properly combined with any other embodiment disclosed herein. The combination of any one of the embodiments disclosed herein with any other embodiments disclosed herein is expressly contemplated.

### BRIEF DESCRIPTION OF THE DRAWINGS

The objects and advantages will be apparent upon consideration of the following detailed description, taken in conjunction with the accompanying drawings, in which like reference characters refer to like parts throughout, and in which:

FIG. 1 illustrates an embodiment of the labeling process of creating a data set for supervised learning, according to certain embodiments.

FIG. 2 illustrates the creation of a fine tuned model and subsequently utilizing the fine tuned model vector space along with pretrained model for additional labeling, according to certain embodiments.

FIG. 3 illustrates ensemble testing of two or more fine tuned models, according to certain embodiments.

FIG. 4 illustrates continual learning in a production release configuration, according to certain embodiments.

FIG. 5 is a schematic representation of labeling candidate selection in pretrained space for model finetuning, according to certain embodiments. Two iterations (middle and right) are shown starting with unlabeled clusters (left), according to certain embodiments,

FIG. 6 illustrates scenarios for addition of unlabeled candidates to labeling queues (1) first time clustering and labeling to create a fine tuned model, (2) once a fine tuned model is created, (3) production OOD cases, according to certain embodiments.

FIG. 7 illustrates clustering using z-score values (same approach for pre-trained and fine tuned space clustering), according to certain embodiments.

FIG. 8 illustrates sample neighborhood for an input from pre-trained space and cluster histogram in pre-trained space (top). Sample neighborhood for an input from fine tuned space and cluster histogram in fine tuned space (bottom), according to certain embodiments

FIGS. 9A-9C show UMAP visualization of pretrained (FIG. 9A) and fine tuned space (FIG. 9B), according to certain embodiments. Two dimensional visualization of the 2 d vectors fed to the last argmax stage of the fine tuned model (FIG. 9C), according to certain embodiments.

FIG. 10 illustrates histograms of single sense and mixed sense clusters in fine tuned space of a binary classifier model, according to certain embodiments.

FIG. 11 compares the uncertainty of a fine tuned binary classifier for false positives with the uncertainty for the same set of false positives in the fine tuned space, according to certain embodiments. The heterogeneity of the cluster the input falls into in the fine tuned space is used as the measure of uncertainty, according to certain embodiments.

FIGS. 12A-12E illustrate the construction stages of an embodiment as well as its deployment configuration, according to certain embodiments.

FIG. 13 illustrates lifelong model learning not only from iterative fine tuning but also from test/deployment input serving as weakly labeled data, according to certain embodiments.

### DETAILED DESCRIPTION

It has been discovered that curation of labeled data sets for training a supervised model on tasks involving supervised learning is one of the practical challenges of machine learning, both in terms of the cost and time involved in curating those labeled data sets. Given there is no well defined methodology for optimal curation of data sets to date, a variety of methods are used in practice to reduce the labeling process such as weak supervised learning or attempts to automate the labeled data creation process with human assistance. However, while models are then evaluated on such data sets to assess their performance, there is no quantitative metric to assess the labeled data set itself, particularly the breadth of coverage of the training set or the methodology used to partition the data set into train and dev/test splits. This ad hoc training data set creation process has a direct bearing on model performance, when the labeled data set is small—a situation that is not so infrequent in practice, given the cost of creating labeled data sets. For instance, a suboptimal split of the labeled data set can not only prevent models from scoring high on the test set but also prevent models from maximally learning from the train set they learn from. Also the labeled data sets are purely used for training and testing the model—they are not used once the model is deployed to score the confidence of model outputs or determine out-of-distribution cases.

In addition to the challenge of optimal curation of labeled data to train supervised models, supervised models—particularly neural networks used for training models on high dimensional data, suffer from two problems during inference—often have the challenge of wrongly choosing a particular class over other classes with a high score (“confidently wrong”) as well as failure on out-of-distribution cases. A model's output on a “near OOD” input poses the additional challenge of determining if a model is successfully generalizing from its train set learning or is just wrong.

Out-of-distribution cases are inevitable in supervised learning since a supervised model only learns the conditional distribution of the labels given the input, which is typically a small subset of the available data, as opposed to learning the underlying distribution the input data comes from by making use of the entirety of available data. One of the primary reasons for models with strong performance on popular benchmarks, but exhibiting poor production performance, is in part due to the inadequate coverage of the input space by the training which in part can be addressed by leveraging a diverse labeled data set at inference time for ensembling or out-of-distribution estimation.

Using models that perform density estimation of the input space to address out-of-distribution scenarios, particularly using their generative capacity (density estimation models often directly or in most cases, with minor enhancements/modifications can be made generative), yields anomalous results, even if its learning of the training set—model generates representative samples of the training set that is far from the actual training set.

Furthermore, with models that learn rich representations in a self-supervised manner (e.g. an autoencoder model like BERT, contrastive and non-contrastive learning methods for images using transformers, Resnets etc.), the need for explicit density estimation is excessive in practice, particularly when such models can learn rich representations without density estimation and can be leveraged to both train a supervised model as well as assist in estimating out-of-distribution cases as described herein. However, the disclosed system and methods do not preclude the use of models that can perform both density estimation as well as learn rich representations (e.g. autoregressive models).

The system and methods described herein offer a working solution to all the problems listed above, including (1) optimal labeling and partitioning of data set for training a supervised model (2) making model outputs interpretable to some degree, and (3) improving model performance by reducing the “confidently wrong” cases and increase a model's Out of distribution (OOD) performance, both of which are done in an interpretable manner, in contrast to the opaque process by which neural networks map input to output. The methods described herein are made possible largely by self-supervised models (also referred to as “foundation models” for their utility to fine tune and direct use as is, without fine tuning as illustrated in the embodiments below) that can learn from an entire corpus as opposed to supervised models whose learning is constrained to labeled data which is limited given the need for labeling by humans.

In one aspect, a system and method is disclosed to improve the efficacy of supervised learning. Specifically the described system and method is described according to the following embodiments.

In some embodiments, the system and method outline a procedure to find candidates for labeling in an optimal manner to reduce the labeling effort which involves humans.

In some embodiments, the system and method outline a procedure to quantitatively assess the labeled data that is created with human involvement.

In some embodiments, the system and method outline a procedure to quantify the uncertainty in labeling an input when multiple humans or autonomous agents label an input and use that measure during test time to measure model's uncertainty on the same input.

In some embodiments, the system and method outline a procedure to partition the labeled data set from the previous step into training and dev/test sets such that the training set maximally spans the labeled space. This serves to both improve model performance and reduce out-of-distribution cases with respect to the labeled data set, at inference time.

In some embodiments, the system and method outline a procedure to quantitatively assess model output at inference time by leveraging off what the model was trained on. This offers a means to disentangle model failures from cases where the model has truly generalized from the training set.

In some embodiments, the system and method outline a procedure to test model on out-of-distribution (OOD) input separate from the test set.

In some embodiments, the system and method outline a procedure to leverage a human labeled data set for algorithmic labeling to expand the human labeled data set with minimal human effort (verifying the automatic labeling as opposed to actually labeling).

In some embodiments, the system and method outline a procedure to leverage the entire labeled data set during model deployment to improve model performance. In some embodiments, the system and method determine one or more of the following: how to utilize the labeled data set as a reference to quantify model uncertainty for a single input; how to use the labeled data set to create an interpretable output label for a given input in contrast to its opaque counterpart where the learning from a subset of the labeled data (the typical use of the training set) is incorporated into the model parameters; and how to effectively multiply the labeled data set by using an ensemble of models, which improves model performance and to quantify model uncertainty.

In some embodiments, the system and method leverage the procedure described above for creating the labeled data set to also be used after model deployment to continue to retrain the model on out-of-distribution cases encountered during production usage.

In some embodiments, an implementation of the system and method described above uses an embedding space that the input is mapped to. This mapping could be performed by a variety of means but not limited to self-supervised methods. Also the input could be one or more modalities such as text, image, audio and the embedding space these modalities are mapped to could be distinct or jointly learned. For the purpose of this document this embedding space or spaces will be collectively referred to as pre-trained space. The model or models that map input to this space are referred to henceforth as pre-trained space mappers. In some embodiments, the pre-trained space is used in one or more of the following ways: to find candidates for labeling optionally removing noise; to partition the input into training and dev/test sets; for predicting out-of-distribution inputs at inference times; to add a level of interpretability to model output; after model deployment to further optimally retrain the model.

In some embodiments, an implementation of the system and method described above uses the embedding space of the supervised models (optionally trained by the methods described herein) that the input is mapped to. The input could be one or more of the modalities such as text, image, audio and the embedding space these modalities are mapped to could be distinct or joined. For the purpose of this document this embedding space or spaces will be collectively referred to as fine tuned space. The model or models that map input to this space are referred to henceforth as fine tuned space mappers. The fine tuned space is used in one or more of the following ways: to partition the input space once a fine tuned model has been bootstrapped into creation (optionally) using the pretrained space; to create an interpretable output label for an input that is a counterpart to the opaque model output; to ascribe confidence to model output and identify those input that the model has difficulty separating into separate classes; for predicting out-of-distribution inputs at inference times; to increase the chances of identifying cases where model is confidently wrong in its output; to add a level of interpretability to the typical opaque model output; after model deployment to create weakly labeled data and use them for subsequent input classification; after model deployment to further optimally retrain the fine tuned model.

In some embodiments, the pretrained space is a vector space created by mapping input to sparse/dense distributed representations.

In some embodiments, the pretrained space includes of learned parameters of a probability distribution.

In some embodiments, the pretrained space is learned by a model performing density estimation (e.g. autoregressive models, BiGANs, Flow models, diffusion models).

In some embodiments, the pretrained space is learned by a model that does not do density estimation but just learns representations (e.g. autoencoder models like BERT).

In some embodiments, the pretrained space mappers are trained in a supervised manner to create fine tuned space mappers.

In some embodiments, pretrained space mappers are distinct and decoupled from fine tuned space mappers.

In some embodiments, where the pretrained and fine tuned space mappers are deep learning architectures including but not limited to transformers, convolutional neural networks (CNNs), recurrent neural networks (RNNs), graph neural networks (GNNs).

In one embodiment, the fine tuned space mapper is a supervised model that is created from fine tuning a self-supervised model which was used to create the pretrained space (pre-trained space mapper).

In the embodiment where a self-supervised model is trained on the entire available input space of interest to map input to the pretrained space and used as follows: mapping training candidate subset that is optionally a subset of the entire available input space and serves as the candidate set for labeling to train the supervised model by mapping this candidate set to the pretrained space by the pretrained space mapper; clustering the training candidate set in the pretrained space to identify cluster centroids that are then chosen for labeling by humans or by some automated method; optionally culling noise from the training candidate set using the pretrained space; choosing candidates for labeling from each cluster where the choice of candidates is determined by the number of classes the supervised model is trained to output; choosing candidates for labeling from the clustering process where the candidates did not form clusters or belong to one; partitioning the labeled data set into train, dev, and test such that, the training set contains the centroids and at least one of the representative samples of the classes or the quantized ranges, if such additional representative samples exist in a cluster, the dev/test contains at least one of the other items in each cluster, the partitioning into dev and test purely being done by the desired dev/test split, the train set contains all the labeled singletons with the exception of a desired number which is added to an OOD set; bootstrapping the finetuning of the supervised model using the labeled data set mentioned in previous step.

In some embodiments, for a supervised model whose output is continuous, candidates for labeling from each cluster could be representative samples of quantized ranges that span the continuous range of interest. In some embodiments, choosing candidates includes applying the clustering process iteratively on the identified clusters with relaxed clustering constraints if the number of clusters is too large for labeling.

In some embodiments, choosing candidates for labeling where the candidates did not form clusters or belong to one includes applying the clustering process iteratively with relaxed or tight clustering constraints on the identified singletons if the singleton set is too small or large for labeling.

In some embodiments, fine tuned space of the bootstrapped model is used for subsequent fine tuning of the supervised model as follows: inputting the entire labeled data set through the fine tuned space model and clustering the entire bootstrapped labeled set in the fine tuned space also; examining the mapping characteristics of the labeled data between the pretrained space and fine tuned space, e.g., by treating the mapping from pretrained space to fine tuned space as a bipartite graph and quantifying the mapping of input from the pretrained space clusters to fine tuned space clusters; using the mapping characteristics to further decide the choice of candidates to label to improve model performance in addition to the use of pre-trained space to choose labeling candidates as described earlier.

In some embodiments, the clusters in pretrained and fine tuned space, as well as the mapping characteristics from pre-trained to fine tuned space, are utilized to estimate out-of-distribution candidates at inference time.

In some embodiments, the heterogeneity measure of the clusters in the fine tuned space is utilized to ascribe confidence scores to model output (this could lead to an additional category of “can't say” in the model output). This helps reduce cases where the model is confidently wrong.

In some embodiments, an ensemble of models optionally trained by the above described methods is utilized to determine model output for each input, particularly using the confidence scores of the model outputs as a metric to weight the model outputs.

In some embodiments, an ensemble of models optionally trained by the above described methods is utilized to estimate out-of-distribution candidates with respect to the train set. This ensemble is not limited to supervised models trained by the method described above—it could include the self-supervised model itself that could potentially be adapted to classify without labeled data, even if only with limited capabilities, and supervised models created by other means.

In some embodiments, an ensemble of models is utilized to output a confidence score that captures model uncertainty where the ensemble is unable to decide on the output with enough certainty. This score reflects both out-of-distribution cases and cases where the input falls into heterogeneous clusters for most models.

In some embodiments, the methods described above are utilized to create additional training data to further train the supervised models on “low confidence” samples it encounters during production use. In this case each “low confidence” sample, regardless of the model classifying it correctly, is treated analogous to a cluster centroid encountered in pretrained space and representative samples of the different classes (or quantized ranges) are picked, if available, to train the supervised model and improve future model performance.

In some embodiments, the utility of train/dev/test data set is extended beyond its traditional utility, as well as the OOD set, before model deployment to continuous lifelong learning by updating it with new data encountered in production that a model struggles with or fails to work, as well as using it to ascribe confidence to model outputs based on the mapping of input from pretrained space to fine tuned space as well as the characteristics of the set the input belongs to in the pretrained and fine tuned space.

In some embodiments, the methods and systems include use of the embedding space created by a model that is trained by some means (e.g. self-supervised, or even supervised) to cluster the unlabeled data candidates, a subset of which is used to train a supervised model.

In some embodiments, the methods and systems include use of the clusters to choose candidates for labeling to train the supervised model.

In some embodiments, the methods and systems include using clustering characteristics of input in the pretrained space as a means to partition the labeled input into train and dev/test sets.

In some embodiments, the methods and systems include training the supervised model with those candidates.

In some embodiments, the methods and systems include use of the fine tuned embedding space of the supervised model to further choose candidates to create newer versions of the fine tuned model.

In some embodiments, the methods and systems include use of one or more embeddings space learned independently or jointly to choose candidates for fine tuning a model.

In some embodiments, the methods and systems include use of two embedding spaces and the mapping characteristics of input between those two spaces as a means to choose candidates for labeling as well as to detect out-of-distribution cases.

In some embodiments, the methods and systems include using clustering characteristics of input in the pretrained and/or fine tuned space as a means to partition the labeled input into train and dev/test sets.

In some embodiments, the methods and systems include use of one or more embedding spaces to generate interpretable outputs.

In some embodiments, the methods and systems include use of one or more embedding spaces to identify out-of-distribution candidates.

In some embodiments, the methods and systems include use of one or more embedding spaces to retrain a model on out-of-distribution cases encountered at inference time.

In some embodiments, the methods and systems include use of one or more embedding spaces to retrain a model on cases it failed at inference time.

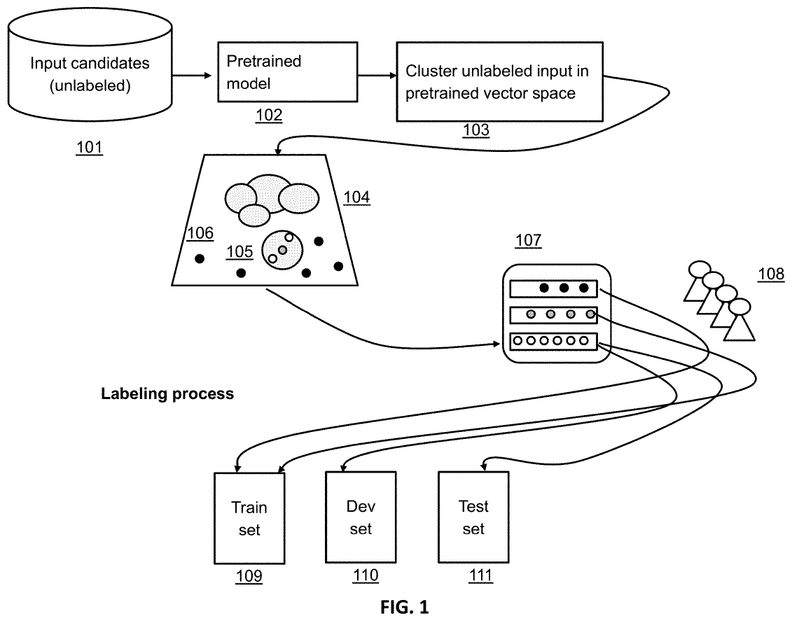

In an embodiment, shown in FIG. 1, at least one self-supervised model or pretrained model (102) is trained on the entire input corpus of interest (text, image etc. or a combination of them). In this example, the entire corpus or optionally a subset of it (assuming such a culling is possible in some instances without the need for labeling), identified in FIG. 1 as input candidates (101) is then fed to the pretrained model to map them to the pretrained vector space. These vectors are then clustered (103) in the pretrained vector space (104) to yield clusters (105) and singletons (106). Unlabeled candidates from these are then chosen and added to separate queues (107) for human labeling (108). The labeled items are added to the train (109), dev (110), or test (111) set based on the queue they belong to. Labeled cluster centroids are added to the train set, labeled cluster children are added either to the dev or test set. Labeled singletons are added to the train set, with the exception of a few that are added to a fourth Out-of-distribution (OOD) set. This selective addition of labeled candidates of input candidates is to ensure the train set maximally represents the underlying data distribution thereby improving the chances of model performance during test and production deployment. Selective addition of labeled candidates provides more unique input to allow the model to maximally learn.

In some embodiments, a fine tuned model is created by starting with a pretrained model (e.g., a trained self-supervised model) and then adding an additional layer (typically called a head) to the pretrained model. In some embodiments, the choice of additional layer is specific to the fine tuning task. For example, when fine tuning a model for a classification task, an additional classification layer is added on top of the pretrained layer. In some embodiments, the weights of the additional layer are updated during the fine tuning task. In other embodiments, the weights of the pretrained model may also be updated during fine tuning. In some embodiments, the choice of when to update the weights is driven by the amount of data available for fine tuning. For example, when there is a large amount of fine tuned data, the pretrained model weights are often updated in addition to updating the weights of the layer added specifically for fine tuning. When the amount of fine tuning data is less, typically the pretrained model weights are frozen and only the weights of the additional layer (the head) are updated. In some embodiments, the choice of number of layers of the pretrained models that are frozen or update during fine tuning is determined by the practitioners based on the amount of data available for fine tuning.

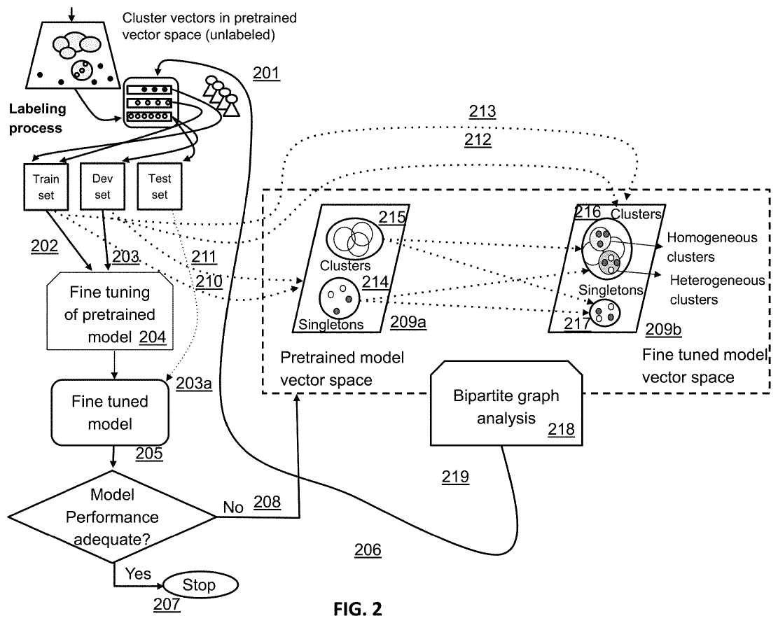

FIG. 2 illustrates an embodiment including creation of a fine tuned model and subsequently utilizing the fine tuned model vector space along with a pretrained model for additional labeling. The labeling process (201) described above in relation to FIG. 1 is used to create train/dev/test sets. The train (202) and dev set (203) are used to fine tune a model (204). In some embodiments, but not necessarily, the pretrained model mentioned above is the model used to create the fine tuned model. The fine tuned model (205) performance on the test set (203a) determines if the model performance needs to be further improved (206) or is adequate (207). If the performance is inadequate (208), then more unlabeled data from the queues are labeled. The choice of data to be labeled is assisted in part by using the fine model's vector space along with the pretrained model vector space. To map an input into a pretrained or fine tuned vector space, a vector representing the input is fed into the pretrained or fine tuned model and transformed into the respective pretrained or finetuned vector space. Specifically, the mapping of the train and dev sets (210, 211) onto the pertained vector (209a) space and fine tuned (209b) space (212, 213) is used to determine the additional candidates that need to be labeled. For instance, the mapping from clusters (215) and singletons (214) in pretrained space (209a) to clusters (216) and singletons (217) in fine tuned space (209b) is used to determine homogeneous clusters (clusters with input terms having the same label) and heterogeneous clusters (clusters with input terms have disparate labels) in the fine tuned space. For example, heterogeneous clusters in fine tuned space are indicative of input cases where the model is likely to have difficulty classifying, and will result in labelling of data that is similar to the data in the heterogeneous clusters. This observation is dependent on the fine tuned model characteristics and the hyperparameters used to fine tune the model. By examining the mapping characteristics of train and dev set (218), between pretrained and fine tuned space, the labeled data helps in identifying model mapping characteristics, as well cluster characteristics and are used to determine the additional labeling that may be required. Examples of this are adding more labeled data for mixed clusters etc, adding more data for singletons in fine tuned space. An example of a clustering characteristics includes whether a cluster is heterogeneous or heterogeneous. Another example of using mapping characteristics is adding more data that is within a number of standard deviations from the mean in pretrained space.

The approach described above can be used to pretrain and fine tune one or more models, with additional selective labeling being performed iteratively if required to improve a fine tuned model performance.

In an embodiment, additional labeling is also done algorithmically (autonomous agents) and a confidence score is assigned to the algorithmically labeled data leveraging the labeled data humans have already created and described in FIG. 1. This algorithmically labeled data is then clustered in the same pretrained vector space and added to the appropriate queues for humans to verify and modify. The confidence score facilitates the ease of verification of automatically labeled data. Algorithmic labeling could occur in the same pretrained vector space or in any vector space of choice.

In an embodiment, when multiple agents, human or autonomous, label a particular input, the disagreement between agents is captured in an uncertainty measure that is used at test time to check a model's uncertainty (or an ensemble uncertainty) on the same input. This approach of using a model's ensemble confidence score for an input is in effect a soft analogue to creating a separate “can't say” class distinct from all classification classes. Such inputs are then logged to continually retrain the model for its full life cycle as described below.

The present disclosure also describes a means to quantify versions of a data set as it is being created as well as compare any two datasets by a comparison metric at a data set level. For instance, two data sets are deemed similar if their comparison metric is 1, orthogonal if 0, and dissimilar if it is −1. Two similar data sets A and B would have a comparison score that would be greater than the comparison score between data set A and C where A and C are more dissimilar compared to A and B. In some embodiments, the comparison score is determined using the average cosine distance between sentences in the data set. For example, if there are M sentences in A and N in B, a dot product would yield M*N values. In some embodiments, the average of the dot products is a measure of the comparison score.

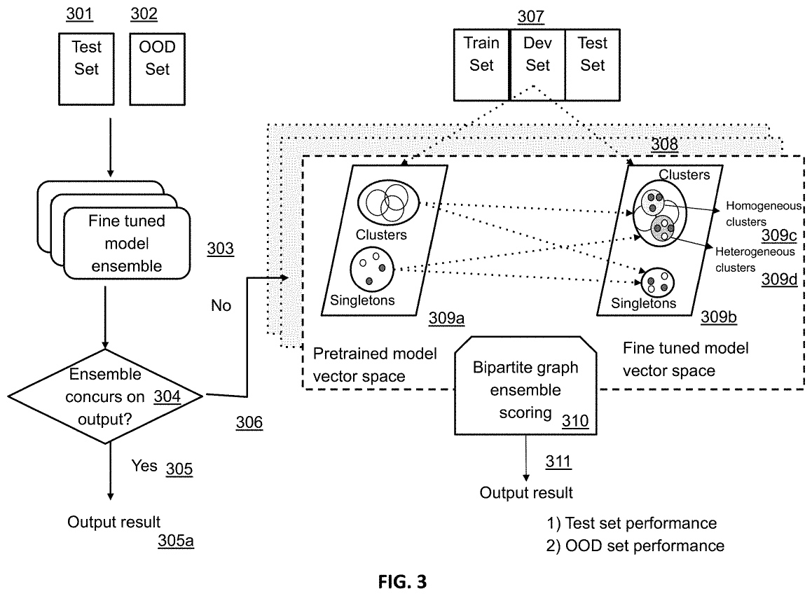

FIG. 3 illustrates an embodiment including ensemble testing of two or more fine tuned models. The Out of Distribution set (OOD) (302) is a subset of those inputs that map from clusters/singletons in pretrained space to singletons in fine tuned space. The test set (301) and OOD set (302) are fed to the ensemble (303) of pretrained and fine tuned model pairs and if the majority of model pairs concur (304) on the label predictions (305), that result is output (305a). For input to the ensemble models where the model pairs don't concur on label prediction (306), the bipartite graph composed of pretrained space sets and fine tuned space sets are used to score model output. Specifically, the train/dev/test sets (307) are mapped on to both vector spaces of each model pair and serve as the labeled substrate to score the input sample in that pair. For example, if an input maps to a fine tuned cluster in a model pair that is a homogeneous cluster (309c) the dominant label of that cluster is the predicted label. In another example, if the input maps to a heterogeneous cluster (309b) in a model pair, then that is suggestive of the model struggling to map the input to a particular label. In both cases, the mixture of labels in that cluster can be used as a confidence score for labeling by the model pair. The input may map to a singleton in the fine tuned space of a model pair too (309b). Additionally, an input may map to one or more clusters in the fine tuned space of a model pair. The mapping of an input in the fine tuned space of a model pair can be used to compute the confidence score for labeling of that input by that model pair. If the ensemble does not agree on labeling of an input, the ensemble output (310) for that input can be determined by the confidence score in the fine tuned space of each model pair, where this score is computed for each bipartite graph associated with a pretrained, fine tuned vector space model pair (308). In some embodiments, this score is based on the heterogeneity of clusters in fine tuned vector space. The ensemble model is tested for both test set performance and OOD set performance (311). In an implementation of the embodiment described above, model performance on a training set was increased from (94%, 87%) to (97%, 92%) by algorithmically partitioning a data set as opposed to human partitioning.

Additionally the individual model performance of two ensemble models trained by the methods described were 94.5% and 95.5% (F1-score) and the ensemble score was 97%. The OOD performance for a second use case with an ensemble of two models, which was also a binary classifier was (93%, 94%).

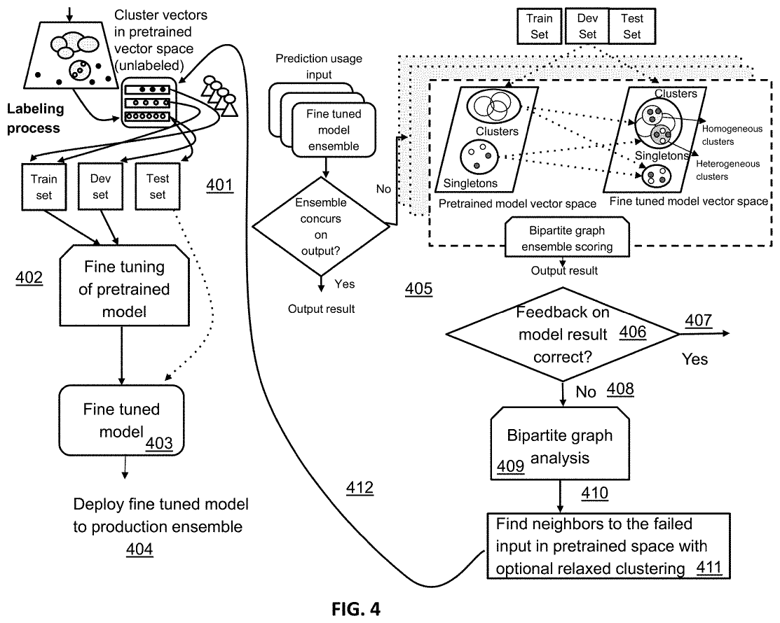

FIG. 4 illustrates an embodiment including continual learning in a production release configuration. In production deployment of a model, any user feedback on model (406) output can be used to improve model performance if the model output was incorrect (408). Also any model output that the ensemble did not agree with each other, or had low confidence scores, can be queued for examination (this could be immediate or deferred as explained below). Such inputs are examined in the bipartite graph composed of pretrained and fine tuned vector space (409). If such inputs map mostly to singletons in the fine tuned space, additional inputs are needed. If such inputs map mostly to clusters, and those clusters are heterogeneous, then additional inputs are needed. Neighbors for these failed inputs are algorithmically picked (411) and added to the labeling queue for labeling 412. In some embodiments, these neighbors are selected by finding the closest unlabeled inputs to the failed input in pretrained space. In other embodiments, neighbors are selected by mapping a subset of the corpus into the fine tuned spaces and finding the closest unlabeled inputs to the failed input in fine tuned space. In some embodiments, the production release configuration incorporates a feedback loop into the labeling (401) and model fine tuning process (402-405) described above. Over time, if already heterogeneous clusters increase in size over a threshold (heterogeneity score for any homogeneous cluster will only monotonically decrease given any input only takes the label of the label of the dominant cluster label; inputs added to a heterogeneous clusters can only be labeled heterogeneous since it is not possible to ascribe a label to them), then those clusters are flagged for user examination.

TABLE 1
Utilization of pretrained and fine tuned
spaces in the different stages

| Stages of model creations and | Pretrained | Fine tuned |
|---|---|---|
| usage | space | space |
| Pretrained model creation | Does not exist | Does not exist |
| Fine tuned model creation | Used | Does not exist |
| Iteratively improve fine tuned model | Used | Used |
| Deploy ensembling | Used | Used |
| Product input failure processing | Used | Used |

Table 1 shows utilization of pretrained and fine tuned spaces in the different stages. Pretrained models are used from the instance they are created through to the full lifespan of the ensemble deployment. Pretrained models are retrained too, as the corpus changes, though this frequency is typically less than fine tuning model retraining. Fine tuned models are retrained at a higher frequency and are also used for the full lifespan of ensemble deployment, until better performing models potentially replace them.

TABLE 2
Labeling priority of input candidates to
serve as a guideline for humans to label

| Labeling category | Qualitative score |
|---|---|
| Cluster centroids | High value |
| At least one child for each cluster | High value |
| representative of a unique output | |
| category/value | |
| Other children in cluster | Low value (other than a few |
| | samples for addition to dev/test |
| | set). Additionally pairwise |
| | similarity of these children |
| | being added should be as low as |
| | possible to maximize the value of |
| | these additions. Adding children |
| | that are very similar to each |
| | other are of lower value |
| Singleton instances | High value |
| Labeling neighbors for input that | High value |
| fails in deployment | |

Table 2 illustrates labeling priority of input candidates to serve as a guideline for humans to label. The separation of unlabeled data into separate categories (clusters, cluster children, singletons), as well as the ordering of unlabeled data in these categories, addresses some of the inefficiencies and problems associated with manual labeling which is not inexpensive in most cases. For instance, it addresses the problem of humans labeling near duplicates if not exact duplicates. It also offers a means to quantify the labeling work not in terms of just raw counts of labeled data, but also the quality of the labeling, particularly the breadth of labeling. For instance, singletons, particularly ones that are farther from each other are more valuable than those close to each other. Cluster children are necessary for dev and test sets, but one only needs to pick a few distant ones in each cluster (algorithmic determination of near and far items make this choice easy). Despite all the algorithmic support, humans play a role in picking diverse as well as representative candidates for each output class of interest—the queues and the ordering of unlabeled candidates purely assist the user in this labeling process.

TABLE 3
Examples of a binary classifier performance for
various partitionings of train/dev/test sets

| | |
|---|---|
| Label | F1-score |

Human partitioned

| | |
|---|---|
| Label1 | 94 |
| Label2 | 87 |

Notes: The values above are for a binary classifier

algorithmically partitioned

| | |
|---|---|
| Label1 | 97 |
| Label2 | 92 |

Notes: Algorithmic partitioning of train - dev/test splits yields
better performance than human partitioning while at the same time
ensuring the train set is composed of centroids and singletons that
enable it to perform better at test and deployment. Algorithmic
partitioning of labeling here means clustering input candidate space
into clusters, and labeling cluster centroids, singletons for adding
to the train set, and labeling cluster children for adding to
dev/test set. Humans perform the choosing of actual candidates for
labeling assisted by the unlabeled candidate queues (cluster pivot
queue, cluster children queue and singleton queue). These are queues
and not sets - the ordering for instance in the singleton queue is
determined by the maximal spanning of singleton items.
Random shuffle

| | |
|---|---|
| Label1 | 94 |
| Label2 | 93 |

NoNotes: A random shuffle of train - dev/test split yields better
performance than human partitioning. However, this still does not imply
random choice for labeling data is an optimal solution given one may
have to train a larger number than the choosing items to label from an
algorithmically partitioned set. If one has the luxury of creating
large amounts of data, random sampling for labeling may very well
suffice - there is no need for algorithmically choosing candidates for
labeling.
Movement test - Singleton move from train to test
(only centroids remain in train set)

| | |
|---|---|
| Label1 | 88 |
| Label2 | 85 |

Notes: The drop in model performance if we move the entire set of
singletons to test from the train set. All these tests are done
keeping the split ratios of the train/dev/test split nearly constant.

TABLE 4
Examples of a binary classifier performance for
various partitionings of train/dev/test sets

| | |
|---|---|
| Label | F1-score |

Model 1
Algorithmically partitioned

| | |
|---|---|
| Label1 | 87 |
| Label2 | 92 |

Notes: Algorithmically partitioned data set performance. This
performance needs to be at least as good as random partitioning. The
benefit of algorithmic partitioning even if the performance is only
as good as a random shuffle is while labeling samples for creating
the data sets, algorithmic partitioning enables a model to learn from
all the singletons and cluster pivots which if randomly chosen may be
spread across train, dev, and test set. So even ignoring model
performance on test set, an algorithmically chosen train dev/test
increases the chances of model doing better at deployment given it
has been exposed to singletons and centroids
Random partitioned

| | |
|---|---|
| Label1 | 85 |
| Label2 | 89 |

Notes: Randomly partitioned data set performance. This performance
serves as the baseline performance for a model trained on an
algorithmically partitioned data set to achieve.
Movement test - Singletons moved to test

| | |
|---|---|
| Label1 | 82 |
| Label2 | 85 |

Notes: Singleton moves cause model performance to drop as expected

Movement test - Centroid move from train to test
(only singletons remain in train set)

| | |
|---|---|
| Label1 | 84 |
| Label2 | 88 |

Notes: Centroid moves cause model performance to drop as expected

Movement test - Centroids children move back from test to train

| | |
|---|---|
| Label1 | 87 |
| Label2 | 92 |

Notes: Centroid children moved back from test to train does not
improve model performance at all since centroids are already present
in the train set. So the only reason to label centroid children is
for dev and test creation. This is one advantage of algorithmically
partitioned data sets - it can help achieve optimal model performance
with optimal labeling.
Model 2
Algorithmically partitioned

| | |
|---|---|
| Label1 | 91 |
| Label2 | 94 |

Notes - performance of a second model on the same algorithmically
partitioned data set in use case 2.
Movement test - Move centroids back

| | |
|---|---|
| Label1 | 92 |
| Label2 | 95 |

Notes - Moving children back from test to train bumps up the
performance by a percent point. This is a small increase compared to
the other experiments of movement where the drop/gain is much higher
In general, movement from test to train of centroid clusters should
not yield a significant gain in performance
Out of Distribution(OOD) performance Model1

| | |
|---|---|
| Label 1 | 87 |
| Label 2 | 91 |

Notes: This is OOD performance of model1 on a sentence set that was
distinct from the training set - these are all sentences that are
longer than the train set sentences. A not so insignificant portion
of these sentences map to singleton sentences even in fine tuned
space.
Out of Distribution (OOD) performance Model2

| | |
|---|---|
| Label 1 | 93 |
| Label 2 | 94 |

Notes: This is OOD performance of model2 on a sentence set that was
distinct from the training set - these are all sentences that are
longer than the train set sentences. A not so insignificant portion
of these sentences map to singleton sentences even in fine tuned
space

Tables 3 and 4 are examples of a binary classifier performance for various partitionings of train/dev/test sets. When the train, dev, and test sets were partitioned algorithmically, the input space was clustered into clusters, and then cluster centroids and singletons were added the train set, while cluster children were added to dev/test set. Performance tests include movement tests that determine the effect of moving certain types of inputs into different sets on model performance, compared to the algorithmic partitioning. For example, as shown in Table 3 and Table 4, when singletons were moved from the train set to the test set, such that only centroids remained in the train set, there was a decrease in model performance compared to algorithmic portioning. A similar drop in model performance relative to algorithmic partitioning was observed when centroids were moved from the train set to the test set, such that only singletons remained in the train set. For example, as shown in Table 4, moving centroid children from the test set to the train set did not improve model performance because the centroids are already present in the train set. While the examples use binary classifiers to illustrate the methods described herein, these methods apply to any supervised learning problem including but not limited to multi class classification, multi class multilabel classification, and continuous output models. Also while the embodiments described herein are examples of treating each input as a whole for classification, the methods described herein do not preclude their use to classify parts of an input, such as tagging terms/phrases for text, or classifying objects in an image, segmenting objects in an image. These diverse sets of problems require appropriate choice of models for the pretrained and fine tuned space to accomplish these tasks. In some embodiments, models for pretrained space and fine tuned space are chosen such that those models yield representations that have good clustering properties, including number of clusters, size of clusters, and heterogeneity of clusters.

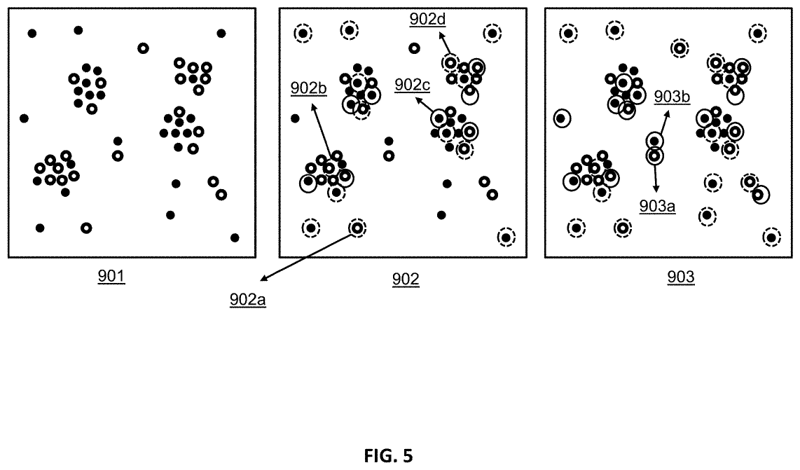

FIG. 5 is an exemplary schematic representation of labeling candidate selection in pretrained space for model fine tuning. Two iterations in the FIG. 902, 903) are shown starting with unlabeled clusters (901) that need to be labeled for a binary classifier. The filled black dots in 901 are the unlabeled inputs of class 1 and the unfilled dots in 901 are the unlabeled inputs of class 2. Dashed outlines are human labeling singletons and cluster centroids that go into train set, while solid outlines are humans labeling cluster children that go into dev/test set. Given an unlabeled input candidate set (101) and a pretrained model (102), the candidate set is sent through the model and clustered in the pretrained space. Pretrained spaces, depending on the nature of self-supervised learning may automatically cluster class types of a particular type, perhaps with some noise (in which case they are direct candidates for ensembling with a fine tuned model with higher performance potentially) or may have mixed clusters composed of the desired class types. In an embodiment, the clustering process is controlled by a hyperparameter—the z-score of the cosine distance of a vector with all vectors in the pretrained space. Once clustered, then further culling of the choice of candidates for labeling is performed by picking labeling candidates that maximally span the input candidate space. For instance in the first iteration of labeling to bootstrap a fine tuned model, the most spread singletons (902a) as well as large cluster centroid (902b) and cluster children of all class categories (902c, 902d) are chosen for labeling. The subsequent iteration, if at all required to achieve the minimum individual model performance, then picks terms that are closer as well as clusters that are smaller (903a, 903b).

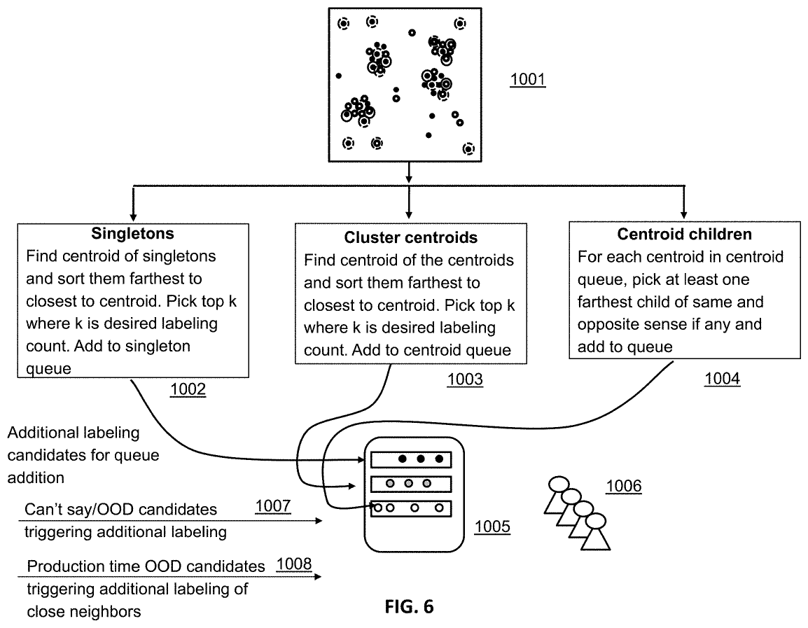

FIG. 6 illustrates exemplary scenarios for addition of unlabeled candidates to labeling queues (1) first time clustering and labeling to create a fine tuned model, (2) additional labeling once a fine tuned model is created, (3) labeling production OOD cases. Candidates from the clusters (1001) are algorithmically picked and three queues (1005) are constructed from singletons (1002), cluster centroids (1003) and cluster children (1004) for labeling by humans (1006). The singleton queue is created by finding the centroid of singletons and sorting singletons from farthest to closest to the centroid of singletons. The top k farthest singletons are added to the singleton queue, where k is the desired labeling count. The cluster centroid queue is created by finding the centroid of the cluster centroids and sorting them from farthest to closest to the centroid of the cluster centroids. The top k farthest cluster centroids are added to the cluster centroid queue, where k is the desired labeling count. The cluster children queue is created by picking at least one of the farthest child from each centroid of the cluster centroid queue of the same sense and at least one of the farthest child from each centroid of the cluster centroid queue of the opposite sense (if any) and adding these children to the cluster children queue. A child is the same sense if its label is the same as the majority of children in that cluster. A child is the opposite sense if its label is different from the majority of children in that cluster. The labeling process, while minimized by optimal choice of candidates to label, continues through the lifetime of the model as a continual learning process aided by methods described herein. Specifically, candidates are added to the labeling queues when fine tuning a model, and after production deployment.

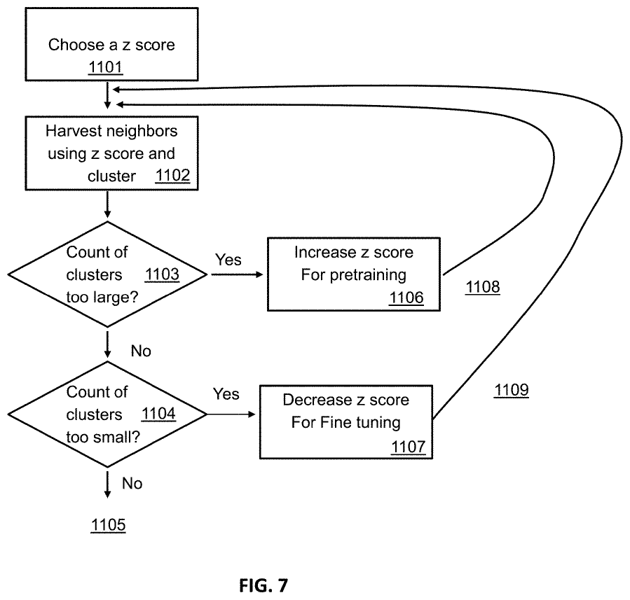

FIG. 7 illustrates an embodiment including clustering using z-score values (same approach for pre-trained and fine tuned space clustering, although potentially with different z-score values that best captures clusters of the desired count and sizes in a particular vector space). Clues to the optimal z-score (1101) ((x−mean)/standard deviation) to pick candidates from the neighbors of a vector can be determined by sampling the neighbors of a few vectors. Then clustering is done by determining the centroid of the chosen vectors (1102). If the count of clusters is too high (1103) (which implies more labeling candidates for pretrained space), then increase z score (1106) and repeat the procedure (1108). If the count of clusters is too small (1104), decrease z-score (1107) and repeat clustering (1109). The choice of z-score values for pretrained vector space and fine tuned vector spaces are different. Multiple class types mix in a cluster in pretrained space, whereas they tend to separate in fine tuned space, the separation caused by the model learning to classify the training inputs. During pretraining, cluster counts are preferably manageable from a labeling effort standpoint. However during fine tuning, more clusters are preferred. It doesn't matter that clusters overlap (see element inclusion count histogram 1204—a single input belongs to more than one cluster—from 2 through 18 cluster inclusions). The appropriate choice of z-score in fine tuned space facilitates this separation with the desired average cluster size, as well as total cluster count. Heterogeneous clusters that still remain given a z-score are then reflective of cases where a model struggles to separate. So a fine tuned space with all the labeled data set mapped onto it serves as an interpretable proxy counterpart to the model weights where the learning from the labeled data set is incorporated therein. The clustering process can be executed efficiently by simply computing the matrix of the dot product of all candidate vectors with themselves, assuming the similarity measure is cosine distance (it need not be cosine distance—could be any other distance measure in practice).

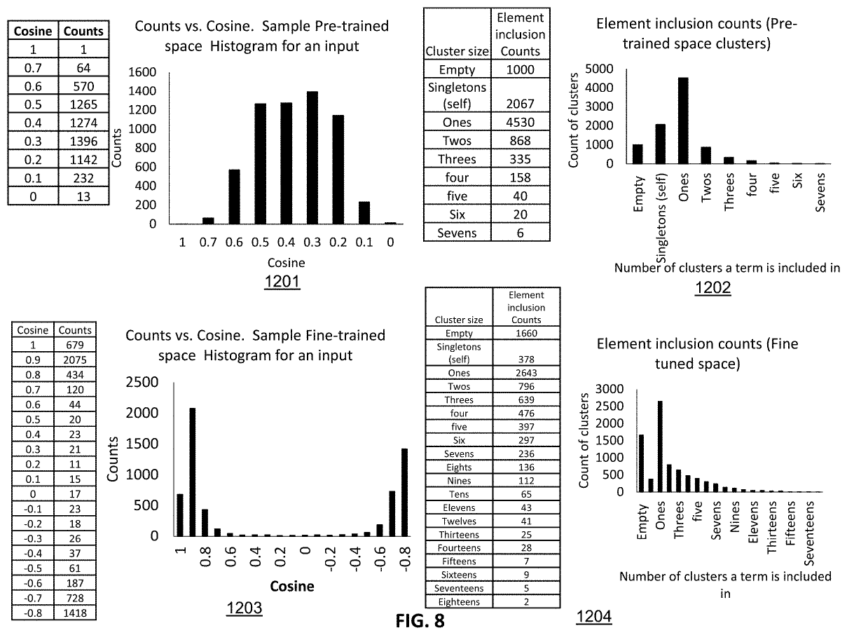

FIG. 8. illustrates an exemplary sample neighborhood for an input from pre-trained space (1201), where cosine is the cosine distance, and cluster histogram in pre-trained space (1202). Also shown is the sample neighborhood for an input from fine tuned space (1203) and cluster histogram in fine tuned space (1204). In this example, output for the pretrained and fine tuned space of a binary classifier, the pretrained space neighborhood for a vector is distinct from the fine tuned neighborhood. The fine tuned neighborhood has neighbors either close or far apart—this is simply the consequence of the fine tuning process. Also the number and size of clusters are quite distinct. This is due to the fact that the z-score hyperparameter for clustering in pretraining and finetuned space are different.

This causes a single input to map to multiple clusters in the fine tuned space, more than it does in the pretrained space, as can be seen by comparing 1202 and 1204. Charts 1202 and 1204 show a histogram of how many clusters each input maps to. For example, in 1202, 2067 inputs map to singletons, while 4530 inputs map to one cluster and 868 inputs map to two clusters. For example, in 1202, each input maps to up to seven clusters in pretrained space, while, in 1204, each input maps to up to seventeen clusters in fine tuned space. These illustrations are the clusters created by passing the entire labeled input through both the pretrained and fine tune models. At deployment time, a new input may remain a singleton or fall into one more of these clusters as seen in 1204. If an input falls into only one cluster, the input's label and uncertainty are determined from that single cluster. In contrast, when an input falls into one or more of these clusters, not only the heterogeneity of a single cluster is a signal, but also the heterogeneity of the multiple clusters it falls into is also a signal of the class type. If an input falls into more than one cluster, each cluster provides information about the class type and certainty of labeling for that input. For example, if an input falls into one or more heterogeneous clusters, that is an indication of uncertainty for the labeling of that input. For example, if an input falls into one or more clusters with opposite sense, that is similarly an indication of uncertainty for the labeling of that input. This is a key distinction of the method described herein—it utilizes the entire labeled data set as a baseline reference in vector spaces to both label new data as well as to complement an ensemble that includes supervised models to determine how to classify a new input. When a supervised model produces an output given an input, despite its known performance on a test set, it is not possible to know if the model is generating a correct output by generalizing beyond the train set, or if it is confidently wrong—here confidently wrong is used to imply the model's classification score for a particular class type is unambiguously high. Vector spaces, particularly of self supervised pretrained models, tend to have predictable outcomes if used correctly. While vector spaces of fine tuned models are subject to the limited learning from train set, utilizing the entire train set as reference to help classify an input, tends to overall reduce not only the vagaries and opacity of model learning when applied to a single input, but also add a level of interpretability to model output, offered by the clustering properties of the entire labeled data set, which can be studied offline and selected for by the right choice of clustering hyperparameters. Leveraging the entire data set by mapping it to pretrained and fine tuned vector spaces, infuses predictability and interpretability to an input to output mapping that is opaque.

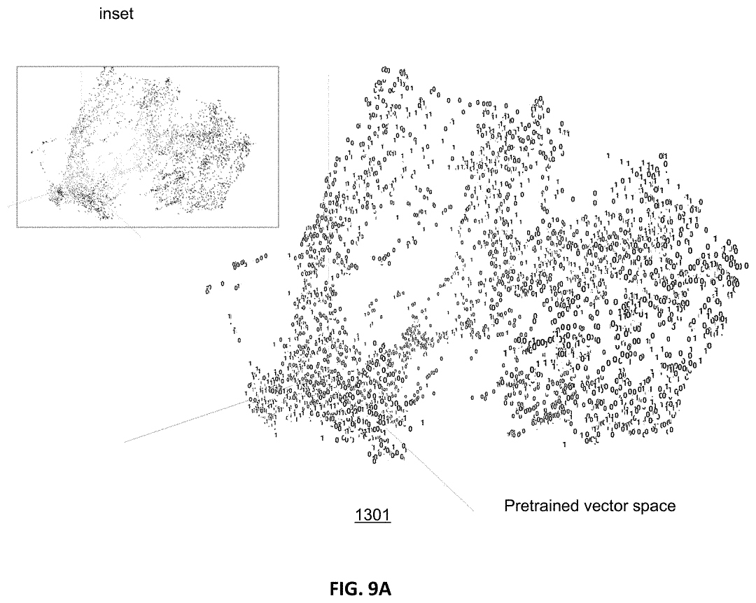

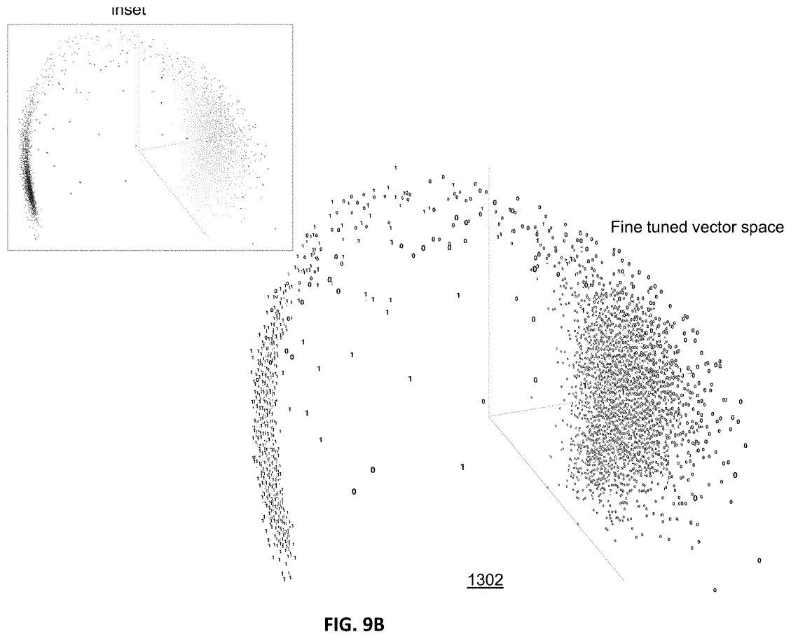

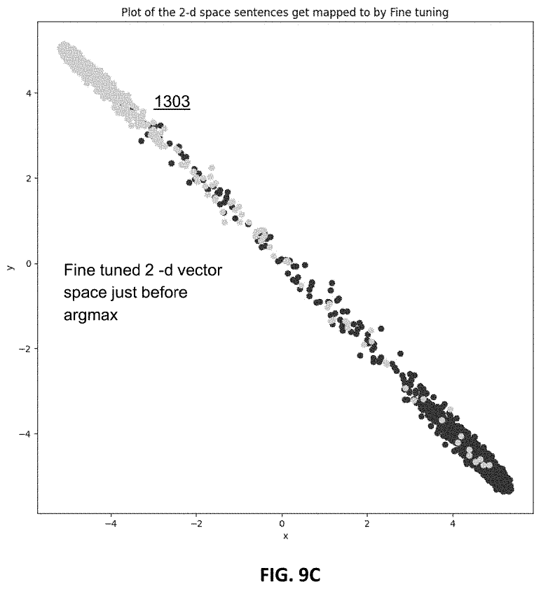

FIGS. 9A-9C is an exemplary UMAP (Uniform Manifold Approximation and Projection) visualization of pretrained (1301) and fine tuned space (1302). In FIG. 9A, a labeled data set for a binary classification is shown (labeled as 0 or 1) mapped to the pretrained vector space 1301. The UMAP reduces the dimensions of the pretrained and fine tuned vector spaces to three dimensions for the purposes of visualization. Note the mixed nature of clusters in the pretrained vector space. Inset is the same space shown without labeling. In FIG. 9B, labeled data set for a binary classification is shown (labeled as 0 or 1) mapped to the fine tuned vector space 1302. Note the two classes are largely separated in the fine tuned vector space. Inset is the same space shown without labeling. In FIG. 9C, labeled data set for a binary classification is shown mapped to the fine-tuned 2-d vector space 1303. Note the two classes are well separated in this space. FIG. 9C shows two dimensional visualization of the 2-d vectors (1303) fed to the last argmax stage of the fine tuned model, where argmax is the operation that finds the argument that provides the maximum value of the target function (e.g., to find the class with the largest predicted probability). In the case of the fine tuned model, the argmax is a binary classifier that provides two values for each input after the input passes through the fine tuned model. The index of the largest value (not the actual value itself) among the two values is picked as the classifier's output. The pretrained space in FIG. 9A shows mixed clusters—the 1 and 0 labels are mixed. The fine tuned space in FIG. 9B largely separates 1 and 0 labels into clusters. The 2-dimensional representation in FIG. 9C shows the model collapsing the vectors to a y=−x line, a nearly ideal separation of the two classes.

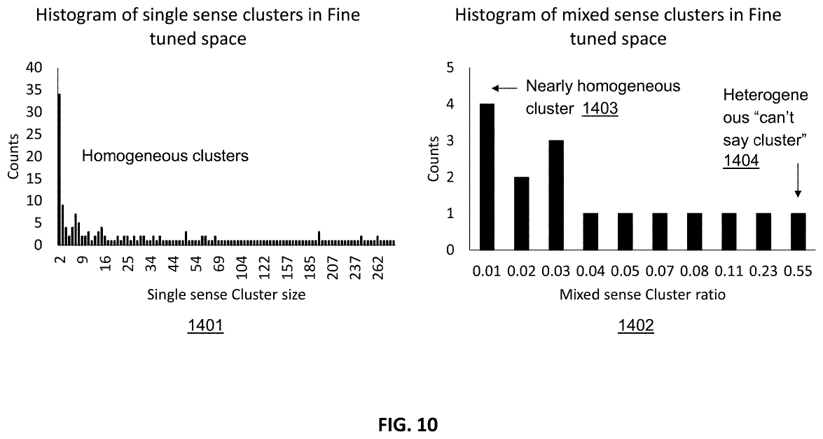

FIG. 10 illustrates histograms of single sense (homogeneous) and mixed sense (heterogeneous) clusters in fine tuned space of a binary classifier model. These two histograms 1401 and 1402 are merely tabular representations of the UMAP visualization of the fine tuned space (1302) shown in FIGS. 9A-9C. Specifically it separates single sense clusters (1401) and mixed sense clusters (1402). The mixed sense clusters 1402 are characterized by a mixed sense cluster ratio, which is low in a nearly homogeneous cluster 1403 and high in a more heterogeneous “can't say” cluster 1404. Note however, in the fine tuned space, unlike pretrained space, there are hardly any mixed sense clusters for this model—the clusters are largely homogeneous.

TABLE 5
Movement of input between the bipartite graph of clusters
in pretrained space and fine tuned space.

| Fine Tuned | Fine Tuned | Fine Tuned | |
|---|---|---|---|
| Space | Space | Space | |
| distribution | distribution | distribution | |
| of test set | of test set | of test set | Notes |
| Human | Clusters: 955 | Clusters: 944 | Given labeling is an |
| partitioned | (49.3%) | (48.8%) | expensive operation, |
| | Singletons: 981 | Singletons: 992 | it is optimal to |
| | (50.7%) | (51.2%) | maximize model |
| | | | learning by training |
| | | | the model on all |
| | | | labeled singletons |
| | | | (with the OOD |
| | | | exception explained |
| | | | in detailed |
| | | | description). The |
| | | | human partitioning |
| | | | almost has equal |
| | | | amounts of both. |
| Random | Clusters: 880 | Clusters: 1731 | Random shuffling does |
| shuffle | (50.7%) | (99.8%) | the same as human; |
| | Singletons: 854 | Singletons: 3 | however the split it |
| | (49.3%) | (0.2%) | does maps most to |
| | | | clusters enabling the |
| | | | model to perform |
| | | | better than human |
| | | | partitioning. |
| | | | Ignoring performance, |
| | | | this isn't an optimal |
| | | | split either since we |
| | | | are not maximally |
| | | | using the singletons |
| | | | for model learning |
| Algorith- | Clusters: 1734 | Clusters: 1115 | Algorithmic split |
| micaly | (100.0%) | (64.3%) | ensures the model is |
| partitioned | Singletons: 0 | Singletons: 619 | trained on clusters. |
| (use case 1) | (0%) | (35.7%) | The OOD test set that |
| (use case 1) | | | is created separately |
| | | | is used to test |
| | | | ensemble model |
| | | | performance. The |
| | | | mapping of items to |
| | | | singletons may be |
| | | | indicative of the |
| | | | label in some use |
| | | | cases. For instance, |
| | | | in this use case, the |
| | | | singletons are |
| | | | largely of one class |
| | | | type which is a |
| | | | factor that can be |
| | | | considered for |
| | | | evaluating model |
| | | | performance either in |
| | | | standalone mode or in |
| | | | ensemble mode. |
| Algorith- | Clusters: 930 | Clusters: 584 | Algorithmic split |
| mically | (100.0%) | (62.8%) | ensures the model is |
| partitioned | Singletons: 0 | Singletons: 346 | trained on clusters. |
| (use case 2) | (0%) | (37.2%) | The OOD test set that |
| | | | is created separately is |
| | | | used to test ensemble |
| | | | model performance. |
| OOD test set | Clusters: 168 | Clusters: 234 | OOD test set for the |
| (use case 2) | (49.6%) | (69%) | use case 2 was evenly |
| | Singletons: 171 | Singletons: 105 | split into clusters |
| | (50.4%) | (31%) | and singletons in the |
| | | | train and test set. |
| | | | The fact that about |
| | | | 69% map to clusters |
| | | | in the fine tuned |
| | | | space is corroboration |
| | | | of good model |
| | | | performance on this |
| | | | OOD set (about 94% |
| | | | F1 score.). About |
| | | | 43 of the singletons |
| | | | map to singletons in |
| | | | the fine tuned space |
| | | | too. In ensemble |
| | | | mode, inputs that map |
| | | | from singletons in |
| | | | pretrained space to |
| | | | singletons in fine |
| | | | tuned space in all |
| | | | model spaces is a |
| | | | strong signal of OOD |
| | | | inputs. In this case, |
| | | | the OOD test set was |
| | | | not taken from |
| | | | singletons. It was |
| | | | sentences harvested |
| | | | from the input space |
| | | | of lengths larger |
| | | | than that used in the |
| | | | test set. It is for |
| | | | this reason some of |
| | | | them mapped to |
| | | | clusters while others |
| | | | remained singletons - |
| | | | these were not |
| | | | selectively picked |
| | | | singletons |

Table 5 illustrates the movement of input between the bipartite graph of clusters in pretrained space and fine tuned space.

TABLE 6
Example where two ensemble models of a binary classification use case don't agree in their output

| | | | | Model 1 | | | Model 2 | | |
|---|---|---|---|---|---|---|---|---|---|
| | | | | | Count of | Count of | | Count of | Count of |
| | | Model 1 | Model 2 | | label0 in | label1 in | | label0 in | label1 in |
| | Ground | output | output | | clusters | clusters | | clusters | clusters |
| | truth | Label0; | Label0; | Confidence | the input | the input | Confidence | the input | the input |
| Input Id | label | Label1 | Label1 | ratio | maps to | maps to | ratio | maps to | maps to |
| data_692 | 0 | (0.0; 1.0) | (1.0; 0.0) | 0.03 | 2 | 73 | 0.06 | 16 | 1 |
| data_5105 | 0 | (0.0; 1.0) | (1.0; 0.0) | 0.18 | 59 | 332 | 0 | 58 | 0 |
| data_2081 | 1 | (0.0; 1.0) | (1.0; 0.0) | 0.71 | 108 | 153 | 0.26 | 89 | 23 |
| data_2253 | 1 | (1.0; 0.0) | (0.0; 1.0) | 0.04 | 172 | 7 | 0.13 | 11 | 86 |
| data_1159 | 1 | (1.0; 0.0) | (0.0; 1.0) | 0.03 | 258 | 8 | 0 | 0 | 188 |
| data_3028 | 0 | (0.0; 1.0) | (1.0; 0.0) | 0.69 | 131 | 189 | 0.12 | 100 | 12 |
| data_4388 | 0 | (0.0; 1.0) | (1.0; 0.0) | 0.58 | 195 | 337 | −1 | 0 | 0 |
| data_970 | 0 | (0.0; 1.0) | (1.0; 0.0) | 0.65 | 100 | 154 | 0.11 | 47 | 5 |

Table 6 shows an example where two ensemble models of a binary classification use case don't agree on in their output. For each model, the table shows the output of the model for each input, the confidence ratio for each output, the number of clusters that input maps to that are a predominantly Label0, and the number of clusters that input maps to that are a predominantly Label1. The confidence ratio is calculated by dividing the number clusters input that maps to that are predominantly the output label by the number of clusters that input maps to that are predominantly other label. The clusters mirror the disagreement in output in their cluster counts in this case, although this need not be the case. For example, for input data_5105, Model 1 assigns the output Label2, and Model 2 assigns the output Label 1. Model 1 maps this input to 59 clusters that are predominantly Label1, and to 332 clusters that are predominantly Label 2, while Model 2 maps this input to 58 clusters that are predominantly Label1 and no clusters that are predominantly Label2. Since Model 1 maps the input to both clusters that are predominantly Label1 and clusters that are predominantly Label2, Model 1 has some uncertainty for the labeling of this input, shown by an uncertainty of 0.18 (calculated by dividing 59 by 332). In contrast, Model 2 maps this input only to clusters that are predominantly Label1 and therefore has an uncertainty of zero for its labeling of this input. The ensemble uncertainty for an input is captured in general by disagreements between individual model output and the corresponding cluster counts in its fine tuned space, as well as disagreements across model results as illustrated in Table 6.

When the uncertainty is beyond a certain threshold the output could be classified as “can't say”—an additional class to the existing classification classes, or alternatively the uncertainty can be used in conjunction with the predicted class.

Table 6 illustrates a couple of aspects unique to the methods disclosed herein. The heterogeneity measure for each model in addition to capturing model uncertainty and OOD, also serves as a predictor of result. So given n classification models in an ensemble, there are effectively double the amount of model results to ensemble and determine the result.

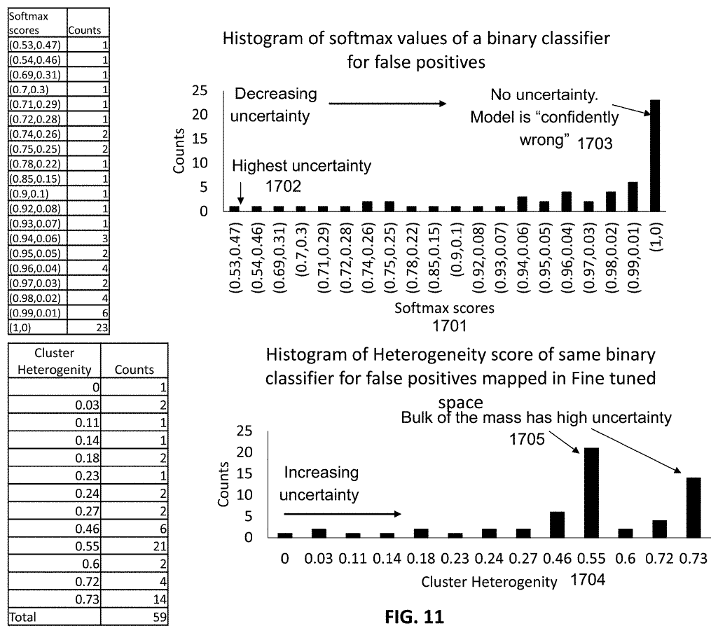

FIG. 11 compares the uncertainty based on the softmax score of a fine tuned binary classifier for false positives 1701, with the uncertainty based on the heterogeneity score for the same set of false positives in the fine tuned vector space 1704. The heterogeneity of the cluster the input falls into in the fine tuned space is used as the measure of uncertainty in 1702. As shown in 1701, when uncertainty is determined based on the softmax score, the model output is “confidently wrong” in most of the false positives: most of the false positives have a softmax score of (1,0), indicating no uncertainty 1703. A smaller number of false positives had high uncertainty 1702 determined based on softmax score. In stark contrast, as shown in 1704, when uncertainty is determined based on heterogeneity score, the bulk of the false positives fall into heterogeneous clusters 1705, reflecting uncertainty in classification using clusters. By using the heterogeneity score, the model assigns a higher uncertainty score to a larger number of false positives. Utilizing the entire labeled data set as a reference to classify any individual input to the model, as described herein, enables reduction of cases where the model is “confidently wrong”. Ensembling of models contributes to this reduction even further—every fine tuned model in the ensemble effectively serves to increase the size of the labeled set by the total labeled data set.

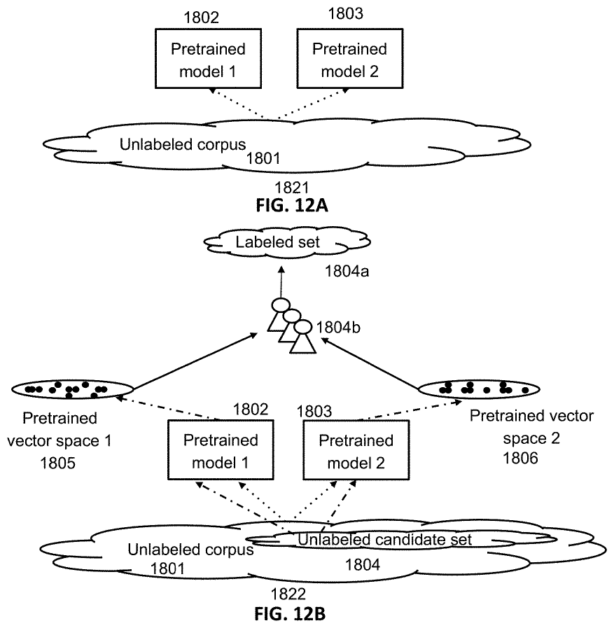

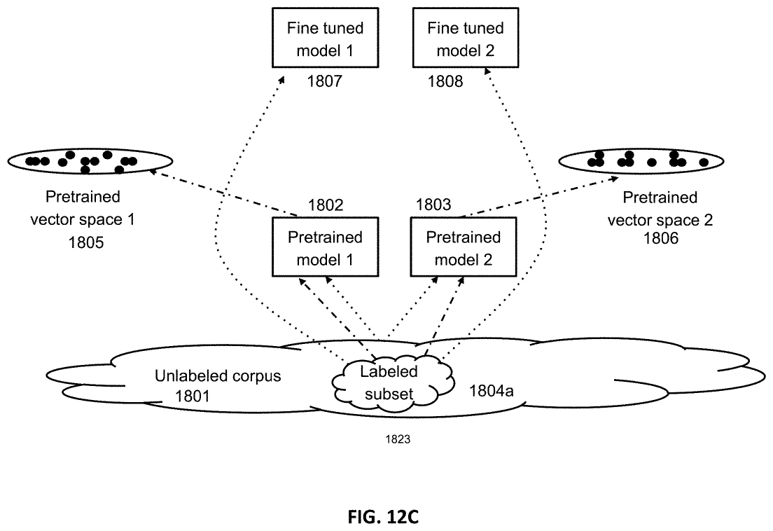

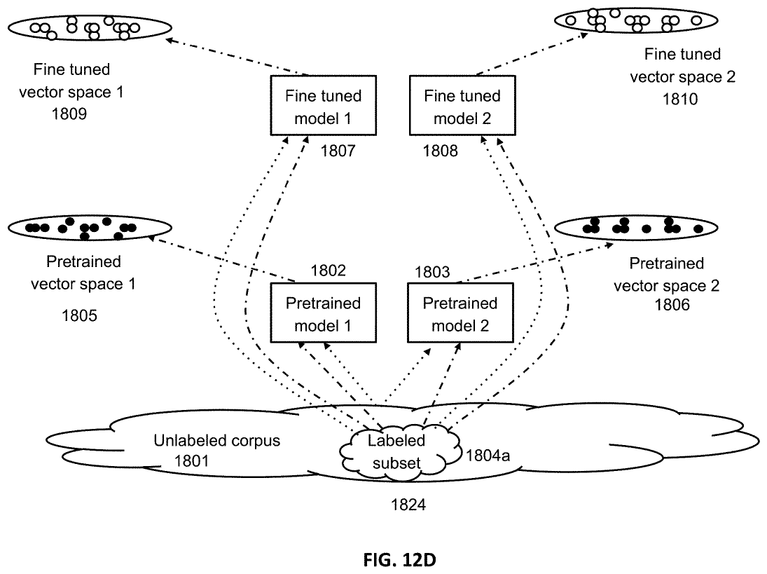

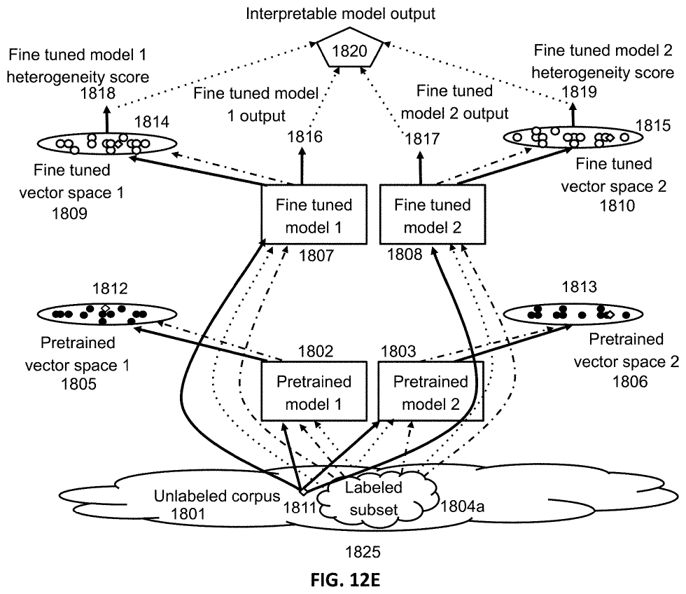

FIGS. 12A-12E illustrate the construction stages of an embodiment as well as its deployment configuration. These stages are already covered in detail above, but re-examined from the perspective of the role the pretrained and fine tuned vector spaces play, which is no less than the output of the trained models. More importantly, this figure illustrates the role of the labeled data set, not only in the creation of the fine tuned models, where the learning from this labeled data set is incorporated into the model parameters, but its utility in the inference of each input fed to the model at inference time. The vector space and the clustering of the entire data not only helps in improving model performance by its clustering characteristics in the various vector spaces it is mapped to, but also adds interpretability to the model output.

As shown in FIG. 12A, an embodiment of the method starts with an unlabeled corpus (1801) that is used to train one or more models (1802, 1803) in a self-supervised manner (1821) (dotted lines show feeding unlabeled corpus 1801 to train pretrained models 1802, 1803). A candidate set (1804) for labeling (this could optionally be a subset of the full corpus) is identified, mapped to the pretrained spaces (1805 and 1806) using models (1802, 1803) (dash dot lines show mapping of candidate set 1804 to pretrained vector spaces 1805, 1806 using pretrained models 1803, 1802), clustered and queued for labeling by humans 1804b (solid lines show queuing for labeling by humans) as described above to create labeled data subset (1804a)—this process is illustrated in FIG. 12B (1822). The labeled data set (1804a) is then used to create fine tuned models (1807, 1808) as illustrated in FIG. 12C (1823) (dotted lines show feeding labeled subset 1804a to train fine tuned models 1807, 1808). The count of two pre trained and fine-tuned models is shown purely for illustrative purposes. There could be any number of fine tuned models depending on the task. As shown in FIG. 12D, the labeled data set is mapped on to the fine model spaces (1809, 1810) by passing the labeled data set (1804a) through models (1807, 1808) (dash dot lines show mapping of labeled dataset 1804a to fine tuned vector spaces 1809, 1810 using fine tuned models 1807, 1808). The choice of the pretrained and fine tuned vector space (including the dimensionality) is model architecture specific—it could be a single layer or a combination of multiple layers, or a cascade of those layers. In some embodiments, this configuration is then used both to add additional input samples from the unlabeled corpus 1801 to the labeling queue and to iteratively improve fine tuned model (1807, 1808) performance, as described above.

Finally, as shown in FIG. 12E (1825), at test or production deployment time, the pretrained models (1802, 1803), fine tuned (1807, 1808) models, the pretrained vectors spaces (1805, 1806), the fine tuned vector spaces (1809, 1810) are all used to classify the input 1811 (shown as a diamond). The input 1811 is mapped on all the vector spaces (1812, 1813, 1814, 1815) (thick solid lines show mapping of input 1811 to the pretrained vector spaces 1805, 1806 and fine tuned vector spaces 1809, 1810) and the mapping characteristics, particularly the clusters the input 1811 maps to the fine tuned spaces is used to calculate the heterogeneity scores (1818, 1819). If the heterogeneity score is near 0, for instance, in the case of a binary classification, that is a prediction of the output analogous to a model prediction output (1816, 1817). When the heterogeneity score is high, it is an indication of the model not being able to clearly classify the input into a particular category. The heterogeneity scores (1818, 1819) are used in conjunction with actual model outputs (1816, 1817) in an ensemble to produce the final interpretable model output (1820) (dotted lines show use of heterogeneity scores 1818, 1819 and model output 1816, 1817 to produce interpretable model output 1820). The interpretable output from an ensemble is based on a combination how many models assign each output and the confidence of the output for each model. A key aspect of this method, as mentioned earlier, is learning from the labeled data set is not only incorporated into the model parameters, but also used in the clustering process, and facilitates the prediction of every single input both opaquely through the learned model parameters and transparently through the clusters in the vector spaces. In this sense, every single input at test times benefits from the labeled data set both implicitly through model parameters and explicitly through the clusters in the vector spaces.

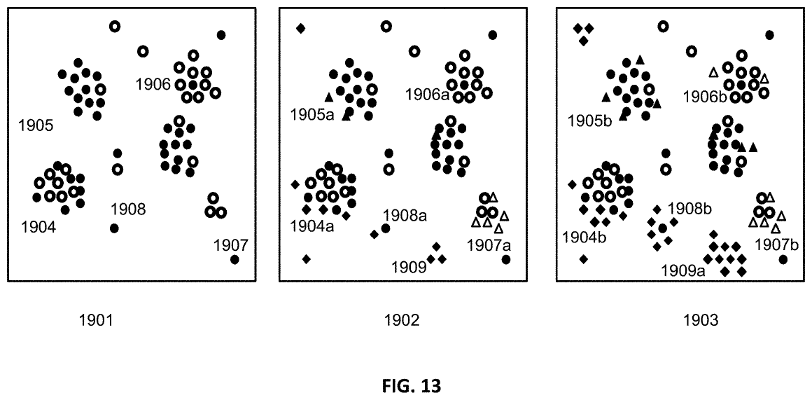

As shown in FIG. 13, in some embodiments, the labeled data set is also expanded for the lifetime of the model, (1901, 1902, 1903), with every user input serving as a weak label (weak here referring to the fact labeling was done only by the heterogeneity measure an input falls into and not by humans), to compute heterogeneity measure of subsequent inputs, with the key condition that if the heterogeneity of a cluster increases above a threshold due to the addition of weak labels (labels model computes at test time and used without human verification) as in 1909a, then those clusters are flagged for human examination of the weak labels within those clusters. The models in essence perform lifelong learning starting off its learning from human labeled data and then weak learning (from clustering) from test/deployment time user input whose mapping onto the fine tuned space serves as weakly labeled data.

FIG. 13 illustrates lifelong model learning not only from iterative fine tuning but also from test/deployment input serving as weakly labeled data. The figure illustrates the progression (1901, 1902, 1903) of cluster growth with additional input during deployment. The solid circles represent class type 1 and hollow circles class type 2 of a binary classifier. These were shown as black circles in 1901 and clustering of deployment time inputs are shown as triangles (solid or hollow for deployment inputs that fall into homogeneous clusters) or diamonds (those inputs that cannot be classified into type 1 or type 2 class) as explained below. Inputs that map to clusters with low heterogeneity score (homogeneous clusters) take on a weak label that is the dominant label of that cluster (1905, 1905a, 1905b; 1906, 1906a, 1906b). Inputs that fall into heterogeneous clusters (1904, 1904a) do not take on a specific label of either class type (or alternatively considered belonging to a “can't say” cluster). Singletons that become clusters or newly emergent clusters (1909, 1909a) also remain “can't say” clusters (1907, 1907a, 1907b, 1908a, 1908b). Growth of these clusters beyond a certain size threshold is considered a trigger to initiate human labeling of those clusters along the lines already described in the methods disclosed herein (adding cluster centroids to train set, and children to dev/set) for iterative model fine tuning.

Those of skill in the art would appreciate that the various illustrations in the specification and drawings described herein can be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware, software, or a combination depends upon the particular application and design constraints imposed on the overall system. Skilled artisans can implement the described functionality in varying ways for each particular application. Various components and blocks can be arranged differently (for example, arranged in a different order, or partitioned in a different way) all without departing from the scope of the subject technology.

Furthermore, an implementation of the communication protocol can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The methods for the communications protocol can also be embedded in a non-transitory computer-readable medium or computer program product, which includes all the features enabling the implementation of the methods described herein, and which, when loaded in a computer system is able to carry out these methods. Input to any part of the disclosed systems and methods is not limited to a text input interface. For example, they can work with any form of user input including text and speech.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this communications protocol can be embodied in other specific forms without departing from the spirit or essential attributes thereof, and accordingly, reference should be had to the following claims, rather than to the foregoing specification, as indicating the scope of the invention.

The communications protocol has been described in detail with specific reference to these illustrated embodiments. It will be apparent, however, that various modifications and changes can be made within the spirit and scope of the disclosure as described in the foregoing specification, and such modifications and changes are to be considered equivalents and part of this disclosure.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, systems, methods and media for carrying out the several purposes of the disclosed subject matter. It is important, therefore, that the claims be regarded as including such equivalent constructions insofar as they do not depart from the spirit and scope of the disclosed subject matter.

It will be appreciated that while one or more particular materials or steps have been shown and described for purposes of explanation, the materials or steps may be varied in certain respects, or materials or steps may be combined, while still obtaining the desired outcome. Additionally, modifications to the disclosed embodiment and the invention as claimed are possible and within the scope of this disclosed invention.

1. A method comprising:
selecting a first plurality of input candidates from a corpus of data;
mapping the first plurality of input candidates onto a pretrained vector space of a pretrained model;
clustering the first plurality of input candidates in the pretrained vector space;
adding the first plurality of input candidates to a plurality of queues for labelling; and
labelling the first plurality of input candidates.

2. The method of claim 1, wherein labelling the first plurality of input candidates is performed by humans.

3. The method of claim 1, wherein labelling the first plurality of input candidates is performed algorithmically.

4. The method of claim 1, wherein labelling comprises identifying cluster centroids in the pretrained vector space.

5. The method of claim 1, wherein the pretrained vector space is created by mapping input to sparse/dense distributed representations.

6. The method of claim 1, wherein the pretrained vector space comprises learned parameters of a probability distribution.

7. The method of claim 1, the pretrained vector space is learned by performing density estimation.

8. The method of claim 1, wherein the pretrained model is selected from a group consisting of transformers, convolutional neural networks, recurrent neural networks, graph neural networks, and combinations thereof.

9. The method of claim 1, further comprising partitioning the labeled first plurality of input candidates into a train set, a development set, a test set, and an out-of-distribution set, wherein partitioning comprises:
adding labeled cluster centroids in the pretrained vector space from the first plurality of input candidates to the train set;
adding labeled cluster children in the pretrained vector space from the first plurality of input candidates to one of the development set and the test set; and
adding labeled singletons in the pretrained vector space from the first plurality of input candidates to one of the train set and the out-of-distribution set.

10. The method of claim 9, further comprising creating a fine tuned model.

11. The method of claim 10, wherein creating the fine tuned model comprises using the pretrained model to create the fine tuned model.

12. The method of claim 10, further comprising assigning a first plurality of outputs using the fine tuned model.

13. The method of claim 10, wherein the fine tuned model is selected from a group consisting of transformers, convolutional neural networks, recurrent neural networks, graph neural networks, and combinations thereof.

14. The method of claim 10, further comprising evaluating performance of the fine tuned model on the test set, wherein evaluating the performance of the fine tuned model comprises:
mapping the test set onto a fine tuned vector space;
clustering the test set in the fine tuned vector space;
quantifying heterogeneity of test set clusters in the fine tuned vector space; and
providing a confidence score for the fine tuned model.

15. The method of claim 10, further comprising labelling a second plurality of input candidates from the corpus of data, wherein labelling the second plurality of input candidates comprises:
mapping the train set and development set onto the pretrained vector space and the fine tuned vector space;
clustering the train set and development set in the pretrained vector space and the fine tuned vector space;
identifying heterogeneous clusters and singletons in the fine tuned vector space;
selecting the second plurality of input candidates such that the second plurality of input candidates are near to at least one of the heterogeneous clusters and singletons in the fine tuned vector space; and
labelling the second plurality of input candidates.

16. The method of claim 15, further comprising partitioning the labeled second plurality of input candidates into the train set, the development set, the test set, and the out-of-distribution set, wherein partitioning comprises:
adding labeled cluster centroids from the second plurality of input candidates to the train set;
adding labeled cluster children from the second plurality of input candidates to one of the development set and the test set; and
adding labeled singletons from the second plurality of input candidates to the one of the train set and the out-of-distribution set.

17. The method of claim 15, wherein labelling of the second plurality of input candidates comprises algorithmically labelling the second plurality of input candidates.

18. The method of claim 15, further comprising assigning the confidence score for the labelling of the second plurality of input candidates using a bipartite graph of the pretrained vector space and the fine tuned vector space.

19. The method of claim 10, further comprising:
evaluating performance of an ensemble of two or more fine tuned models on the test set, wherein evaluating the performance of the ensemble of two or more fine tuned models comprises determining whether the ensemble of two or more fine tuned models concur on an output;
mapping the train, development, and test sets onto one or more pairs of pretrained vector spaces and fine tuned vector spaces; and
assigning a confidence score for each of the two or more fine tuned models using a bipartite graph for each of the one or more pairs of pretrained vector spaces and fine tuned vector spaces.

20. The method of claim 10, further comprising:
selecting a third plurality of input candidates from the corpus of data;
labeling the third plurality of input candidates using the fine tuned model;
mapping the third plurality of input candidates onto the pretrained vector space and a fine tuned vector space;
clustering the third plurality of input candidates in the pretrained vector space and the fine tuned vector space;
identifying heterogeneous clusters and singletons in the fine tuned vector space; and
assigning a confidence score for the labelling of the third plurality of input candidates using a bipartite graph of the pretrained vector space and the fine tuned vector space.

21. The method of claim 10, further comprising:
labeling a third plurality of input candidates using an ensemble of two or more fine tuned models on the third plurality of input candidates;
determining whether the ensemble of two or more fine tuned models concur on labeling of the third plurality of input candidates;
mapping the third plurality of input candidates onto one or more pairs of pretrained vector spaces and fine tuned vector spaces; and
assigning a confidence score for each of the two or more fine tuned models using a bipartite graph for each of the one or more pairs of pretrained vector spaces and fine tuned vector spaces.

22. The method of claim 20, further comprising
selecting a plurality of failed inputs for examination, wherein the plurality of failed inputs are inputs of the third plurality of inputs candidates that have a low confidence score;
selecting a plurality of neighbors of each of the plurality of failed inputs;
labelling the plurality of neighbors; and
partitioning the plurality of neighbors onto the train set, the development set, the test set, and the out-of-distribution set.

23. The method of claim 21, further comprising
selecting a plurality of failed inputs for examination, wherein the plurality of failed inputs are inputs of the third plurality of inputs candidates that have a low confidence score;
selecting a plurality of neighbors of each of the plurality of failed inputs;
labelling the plurality of neighbors; and
partitioning the plurality of neighbors onto the train set, the development set, the test set, and the out-of-distribution set.

24. The method of claim 22, wherein partitioning the plurality of neighbors comprises:
adding labeled cluster centroids from the plurality of neighbors to the train set;
adding labeled cluster children from the plurality of neighbors to one of the development set and the test set; and
adding labeled singletons from the plurality of neighbors to one of the train set and the out-of-distribution set.

25. The method of claim 23, wherein partitioning the plurality of neighbors comprises:
adding labeled cluster centroids from the plurality of neighbors to the train set;
adding labeled cluster children from the plurality of neighbors to one of the development set and the test set; and
adding labeled singletons from the plurality of neighbors to one of the train set and the out-of-distribution set.

26. A system comprising:
a non-transitory memory; and
one or more hardware processors configured to read instructions from the non-transitory memory that, when executed cause the one or more hardware processors to perform operations comprising:
selecting a first plurality of input candidates from a corpus of data;
mapping the first plurality of input candidates onto a pretrained vector space of a pretrained model;
clustering the first plurality of input candidates in the pretrained vector space;
adding the first plurality of input candidates to a plurality of queues for labelling; and
labelling the first plurality of input candidates.

27. The system of claim 26, wherein the operations further comprise partitioning the labeled first plurality of input candidates into a train set, a development set, a test set, and an out-of-distribution set, wherein partitioning comprises:
adding labeled cluster centroids in the pretrained vector space from the first plurality of input candidates to the train set;
adding labeled cluster children in the pretrained vector space from the first plurality of input candidates to one of the development set and the test set; and
adding labeled singletons in the pretrained vector space from the first plurality of input candidates to one of the train set and the out-of-distribution set.

28. The system of claim 27, wherein the operations further comprise creating a fine tuned model.

29. The system of claim 28, wherein the operations further comprise evaluating performance of the fine tuned model on the test set, wherein evaluating the performance of the fine tuned model comprises:
mapping the test set onto a fine tuned vector space;
clustering the test set in the fine tuned vector space;
quantifying heterogeneity of test set clusters in the fine tuned vector space; and
providing a confidence score for the fine tuned model.

30. The system of claim 28, wherein the operations further comprise labelling a second plurality of input candidates from the corpus of data, wherein labelling the second plurality of input candidates comprises:
mapping the train set and development set onto the pretrained vector space and the fine tuned vector space;
clustering the train set and development set in the pretrained vector space and the fine tuned vector space;
identifying heterogeneous clusters and singletons in the fine tuned vector space;
selecting the second plurality of input candidates such that the second plurality of input candidates are near to at least one of the heterogeneous clusters and singletons in the fine tuned vector space; and
labelling the second plurality of input candidates.

31. The system of claim 28, wherein the operations further comprise:
evaluating performance of an ensemble of two or more fine tuned models on the test set, wherein evaluating the performance of the ensemble of two or more fine tuned models comprises determining whether the ensemble of two or more fine tuned models concur on an output;
mapping the train, development, and test sets onto one or more pairs of pretrained vector spaces and fine tuned vector spaces; and
assigning a confidence score for each of the two or more fine tuned models using a bipartite graph for each of the one or more pairs of pretrained vector spaces and fine tuned vector spaces.

32. The system of claim 28, wherein the operations further comprise:
selecting a third plurality of input candidates from the corpus of data;
labeling the third plurality of input candidates using the fine tuned model;
mapping the third plurality of input candidates onto the pretrained vector space and a fine tuned vector space;
clustering the third plurality of input candidates in the pretrained vector space and the fine tuned vector space;
identifying heterogeneous clusters and singletons in the fine tuned vector space; and
assigning a confidence score for the labelling of the third plurality of input candidates using a bipartite graph of the pretrained vector space and the fine tuned vector space.

33. The system of claim 28, wherein the operations further comprise:
labeling a third plurality of input candidates using an ensemble of two or more fine tuned models on the third plurality of input candidates;
determining whether the ensemble of two or more fine tuned models concur on labeling of the third plurality of input candidates;
mapping the third plurality of input candidates onto one or more pairs of pretrained vector spaces and fine tuned vector spaces; and
assigning a confidence score for each of the two or more fine tuned models using a bipartite graph for each of the one or more pairs of pretrained vector spaces and fine tuned vector spaces.

34. The system of claim 32, wherein the operations further comprise
selecting a plurality of failed inputs for examination, wherein the plurality of failed inputs are inputs of the third plurality of input candidates that have a low confidence score;
selecting a plurality of neighbors of each of the plurality of failed inputs;
labelling the plurality of neighbors; and
partitioning the plurality of neighbors onto the train set, the development set, the test set, and the out-of-distribution set.

35. The system of claim 33, wherein the operations further comprise
selecting a plurality of failed inputs for examination, wherein the plurality of failed inputs are inputs of the third plurality of input candidates that have a low confidence score;
selecting a plurality of neighbors of each of the plurality of failed inputs;
labelling the plurality of neighbors; and
partitioning the plurality of neighbors onto the train set, the development set, the test set, and the out-of-distribution set.

36. A non-transitory computer-readable medium storing instructions that, when executed by one or more hardware processors, cause the one or more hardware processors to perform operations comprising:
selecting a first plurality of input candidates from a corpus of data;
mapping the first plurality of input candidates onto a pretrained vector space of a pretrained model;
clustering the first plurality of input candidates in the pretrained vector space;
adding the first plurality of input candidates to a plurality of queues for labelling; and
labelling the first plurality of input candidates.

37. The non-transitory computer-readable medium of claim 36, wherein the operations further comprise partitioning the labeled first plurality of input candidates into a train set, a development set, a test set, and an out-of-distribution set, wherein partitioning comprises:
adding labeled cluster centroids in the pretrained vector space from the first plurality of input candidates to the train set;
adding labeled cluster children in the pretrained vector space from the first plurality of input candidates to one of the development set and the test set; and
adding labeled singletons in the pretrained vector space from the first plurality of input candidates to one of the train set and the out-of-distribution set.

38. The non-transitory computer-readable medium of claim 37, wherein the operations further comprise creating a fine tuned model.

39. The non-transitory computer-readable medium of claim 38, wherein the operations further comprise evaluating performance of the fine tuned model on the test set, wherein evaluating the performance of the fine tuned model comprises:
mapping the test set onto a fine tuned vector space;
clustering the test set in the fine tuned vector space;
quantifying heterogeneity of test set clusters in the fine tuned vector space; and
providing a confidence score for the fine tuned model.

40. The non-transitory computer-readable medium of claim 38, wherein the operations further comprise labelling a second plurality of input candidates from the corpus of data, wherein labelling the second plurality of input candidates comprises:
mapping the train set and development set onto the pretrained vector space and the fine tuned vector space;
clustering the train set and development set in the pretrained vector space and the fine tuned vector space;
identifying heterogeneous clusters and singletons in the fine tuned vector space;
selecting the second plurality of input candidates such that the second plurality of input candidates are near to at least one of the heterogeneous clusters and singletons in the fine tuned vector space; and
labelling the second plurality of input candidates.

41. The non-transitory computer-readable medium of claim 38, wherein the operations further comprise:
evaluating performance of an ensemble of two or more fine tuned models on the test set, wherein evaluating the performance of the ensemble of two or more fine tuned models comprises determining whether the ensemble of two or more fine tuned models concur on an output;
mapping the train, development, and test sets onto one or more pairs of pretrained vector spaces and fine tuned vector spaces; and
assigning a confidence score for each of the two or more fine tuned models using a bipartite graph for each of the one or more pairs of pretrained vector spaces and fine tuned vector spaces.

42. The non-transitory computer-readable medium of claim 38 wherein the operations further comprise:
selecting a third plurality of input candidates from the corpus of data;
labeling the third plurality of input candidates using the fine tuned model;
mapping the third plurality of input candidates onto the pretrained vector space and a fine tuned vector space;
clustering the third plurality of input candidates in the pretrained vector space and the fine tuned vector space;
identifying heterogeneous clusters and singletons in the fine tuned vector space; and
assigning a confidence score for the labelling of the third plurality of input candidates using a bipartite graph of the pretrained vector space and the fine tuned vector space.

43. The non-transitory computer-readable medium of claim 38, wherein the operations further comprise:
labeling a third plurality of input candidates using an ensemble of two or more fine tuned models on the third plurality of input candidates;
determining whether the ensemble of two or more fine tuned models concur on labeling of the third plurality of input candidates;
mapping the third plurality of input candidates onto one or more pairs of pretrained vector spaces and fine tuned vector spaces; and
assigning a confidence score for each of the two or more fine tuned models using a bipartite graph for each of the one or more pairs of pretrained vector spaces and fine tuned vector spaces.

44. The non-transitory computer-readable medium of claim 42, wherein the operations further comprise
selecting a plurality of failed inputs for examination, wherein the plurality of failed inputs are inputs of the third plurality of input candidates that have a low confidence score;
selecting a plurality of neighbors of each of the plurality of failed inputs;
labelling the plurality of neighbors; and
partitioning the plurality of neighbors onto the train set, the development set, the test set, and the out-of-distribution set.

45. The non-transitory computer-readable medium of claim 43, wherein the operations further comprise
selecting a plurality of failed inputs for examination, wherein the plurality of failed inputs are inputs of the third plurality of input candidates that have a low confidence score;
selecting a plurality of neighbors of each of the plurality of failed inputs;
labelling the plurality of neighbors; and
partitioning the plurality of neighbors onto the train set, the development set, the test set, and the out-of-distribution set.
